(19) United States
(12) Patent Application Publication
(10) Pub. No.: US 2026/0001023 A1
(43) Pub. Date: Jan. 1, 2026

(54) NETWORK STRUCTURE, POROUS COMPLEX, METHOD OF PRODUCING NETWORK STRUCTURE, AND METHOD OF PRODUCING POROUS COMPLEX

(71) Applicant: NGK INSULATORS, LTD., Nagoya-Shi (JP)

(72) Inventors: Yunie IZUMI, Nisshin-Shi (JP); Kenichi HIDAKA, Nagoya-Shi (JP); Mimika NOGUCHI, Ichinomiya-Shi (JP); Akihiro MIURA, Nagoya-Shi (JP); Genki YAMAGUCHI, Komaki-Shi (JP)

(73) Assignee: NGK INSULATORS, LTD., Nagoya-Shi (JP)

(21) Appl. No.: 19/318,518

(22) Filed: Sep. 4, 2025

Related U.S. Application Data
(63) Continuation of application No. PCT/JP2024/011723, filed on Mar. 25, 2024.

(30) Foreign Application Priority Data
Mar. 29, 2023 (JP) 2023-053026

(51) Int. Cl. B01D 46/24; B01D 29/11; B01D 39/20; B01D 46/00

(52) U.S. Cl. CPC B01D 46/2482; B01D 29/111; B01D 39/2072; B01D 46/0001; B01D 46/2476; B01D 2239/10; B01D 2239/1216; B01D 2239/1241

(57) ABSTRACT

A network structure having a novel structure is obtained by firing an aggregate of silica gel particles. The network structure includes a plurality of granular portions formed of silica and a plurality of joining portions formed of silica and connecting the granular portions to form a three-dimensional mesh-connected continuum together with the granular portions. For example, the network structure may be formed on a base material having air permeability.

### CROSS-REFERENCE TO RELATED APPLICATIONS

The present application is a continuation application of International Application No. PCT/JP2024/011723 filed on Mar. 25, 2024, which claims priority to Japanese Patent Application No. JP2023-53026 filed in the Japan Patent Office on Mar. 29, 2023. The contents of these applications are incorporated herein by reference in their entirety.

### TECHNICAL FIELD

The present invention relates to a network structure, a porous complex, a method of producing the network structure, and a method of producing the porous complex.

### BACKGROUND ART

Vehicles or the like equipped with a diesel engine or a gasoline engine include a filter that collects particulate matter contained in an exhaust gas. As one example of such a filter, a honeycomb filter is used, in which a porous honeycomb base material includes a plurality of cells, some of which have a mesh sealing part at their opening on the outflow side and the remainder of which have a mesh sealing part at their opening on the inflow side.

For example, the honeycomb filter disclosed in Japanese Patent Application Laid-Open No. 2012-200642 (Document 1) includes a porous collection layer provided on the inner surfaces of cells that have a mesh sealing part at their opening on the outflow side. The collection layer is configured by bonding or entanglement of a plurality of particles and includes, as these particles, flat plate-like particles. The honeycomb filter disclosed in Document 1 can suppress an increase in initial pressure loss and a rise in pressure loss when particulate matter is deposited thereon.

In the honeycomb filter disclosed in WO/2020/194681 (Document 2), the collection layers provided in predetermined cells have an arithmetical mean height of greater than or equal to 0.1 μm and less than or equal to 12 μm and a mean membrane thickness of greater than or equal to 10 μm and less than or equal to 40 μm, the arithmetical mean height indicating surface roughness. This achieves a reduction in pressure loss and an improvement in the efficiency of collecting particulate matter.

As described above, techniques for improving the efficiency of collecting particulate matter or the like while reducing pressure loss in order to improve fuel consumption are proposed for porous complexes configuring honeycomb filters. Since there is a tradeoff relationship between a reduction in pressure loss and an improvement in collection efficiency, it is not easy to reduce pressure loss while achieving high collection efficiency. However, due to recent tightening regulations, there is demand for the ability to further balance a reduction in pressure loss and an improvement in collection efficiency.

Meanwhile, filters are conventionally being used in various fields in order to separate fine particles from a fluid containing the fine particles or in order to increase the concentration of fine particles in a fluid. The separation efficiency of such a filter will deteriorate over time because fine particles may adhere to the filter when separated from a fluid. Thus, there is demand for a novel structure in order to avoid deterioration in separation efficiency.

### SUMMARY OF THE INVENTION

It is an object of the present invention to provide a network structure having a novel structure. The network structure may be used for, for example, a filter that separates fine particles from a fluid.

Aspect 1 of the present invention is a network structure that includes a plurality of granular portions formed of silica, and a plurality of joining portions formed of silica and connecting the plurality of granular portions to form a three-dimensional mesh-connected continuum together with the plurality of granular portions.

According to Aspect 1 of the present invention, it is possible to provide a network structure having a novel structure.

Aspect 2 of the present invention is the network structure according to Aspect 1, in which the plurality of granular portions have a mean particle diameter of greater than or equal to 0.8 μm and less than or equal to 10 μm.

Aspect 3 of the present invention is the network structure according to Aspect 1 (or according to Aspect 1 or 2), in which a chlorine content is less than 10 ppm on a weight basis, and a sulfur content is less than 0.01 wt %.

Aspect 4 of the present invention is a porous complex that includes a base material that is a porous sintered body having air permeability, and the network structure according to Aspect 1 (or according to any one of Aspects 1 to 3), the network structure being provided on the base material.

Aspect 5 of the present invention is the porous complex according to Aspect 4, in which the network structure has a mean membrane thickness of greater than or equal to 5 μm and less than or equal to 200 μm above the base material.

Aspect 6 of the present invention is the porous complex according to Aspect 4 (or according to Aspect 4 or 5), in which the base material has a mean pore diameter of greater than or equal to 10 μm and less than or equal to 30 μm.

Aspect 7 of the present invention is the porous complex according to Aspect 4 (or according to any one of Aspects 4 to 6) that further includes an upper layer provided on the network structure, the upper layer being a porous sintered body that has air permeability and has a smaller mean pore diameter than the base material.

Aspect 8 of the present invention is the porous complex according to Aspect 7, in which the upper layer is formed of alumina.

Aspect 9 of the present invention is the porous complex according to Aspect 7 (or according to Aspect 7 or 8), in which the upper layer has a mean pore diameter of greater than or equal to 1.0 μm and less than or equal to 1.5 μm.

Aspect 10 of the present invention is the porous complex according to Aspect 7 (or according to any one of Aspects 7 to 9), in which the upper layer has a mean membrane thickness of greater than or equal to 15 μm and less than or equal to 40 μm.

Aspect 11 of the present invention is the porous complex according to any one of Aspects 4 to 6 that serves as a filter that separates a microorganism contained in a liquid from the liquid.

According to Aspect 11 of the present invention, it is possible to suppress a decrease in filtration rate.

Aspect 12 of the present invention is the porous complex according to any one of Aspects 7 to 10 that serves as a particulate filter that collects particulate matter contained in an exhaust gas exhausted from a gasoline engine or a diesel engine.

According to Aspect 12 of the present invention, it is possible to provide a porous complex with high collection efficiency and low pressure loss.

Aspect 13 of the present invention is a method of producing a network structure. The method includes a) forming an aggregate of silica gel particles having a mean particle diameter of greater than or equal to 0.1 μm and less than or equal to 5.0 μm, and b) obtaining a network structure formed of silica by heating the aggregate at a temperature of higher than or equal to 1200° C. and lower than or equal to 1400° C. for 0.5 hours or more and two hours or less.

Aspect 14 of the present invention is the method of producing a network structure according to Aspect 13, in which the silica gel particles have a mean pore volume of higher than or equal to 0.2 ml/g and lower than or equal to 3.0 ml/g.

Aspect 15 of the present invention is the method of producing a network structure according to Aspect 13 (or according to Aspect 14), in which a chlorine content in the silica gel particles is higher than or equal to 20 ppm on a weight basis and lower than or equal to 0.01 wt %, and a sulfur content in the silica gel particles is lower than or equal to 0.1 wt %.

Aspect 16 of the present invention is the method of producing a network structure according to Aspect 13 (or according to any one of Aspects 13 to 15), in which in the operation a), the aggregate is formed by forming a slurry containing the silica gel particles.

Aspect 17 of the present invention is a method of producing a porous complex. The method includes c) preparing a base material that is a porous sintered body having air permeability, and d) by the method of producing a network structure according to any one of claims 13 to 16, forming the network structure on the base material.

Aspect 18 of the present invention is the method of producing a porous complex according to Aspect 17, in which in the operation a), the aggregate is formed on the base material by depositing the silica gel particles on the base material.

Aspect 19 of the present invention is the method of producing a porous complex according to Aspect 18, in which in the operation a), the silica gel particles are deposited to a thickness of greater than or equal to 20 μm and less than or equal to 50 μm on the base material.

Aspect 20 of the present invention is the method of producing a porous complex according to Aspect 18 or 19, in which in the operation a), the aggregate of the silica gel particles is formed on the base material by reducing pressure inside the base material while bringing a slurry containing the silica gel particles into contact with the base material.

Aspect 21 of the present invention is the method of producing a porous complex according to Aspect 17 (or according to any one of Aspects 17 to 20). The method includes e) depositing an upper-layer material particles on the network structure, the upper-layer material particles having a mean particle diameter of greater than or equal to 0.05 μm and less than or equal to 1.0 μm, and f) forming an upper layer by heating the upper-layer material particles, the upper layer being a porous sintered body having air permeability and having a smaller mean pore diameter than the base material.

Aspect 22 of the present invention is the method of producing a porous complex according to Aspect 21, in which the upper-layer material particles are alumina particles.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a plan view showing a porous complex in simplified form.

FIG. 2 is a sectional view showing part of the porous complex.

FIG. 3 shows a SEM image of a longitudinal section of the porous complex that includes a collection layer.

FIG. 4 is a simplified diagram of the structure shown in FIG. 3.

FIG. 5A shows a SEM image obtained by observing a surface of a lower layer in a state in which only the lower layer is formed on a base material.

FIG. 5B is a simplified diagram of the structure shown in FIG. 5A.

FIG. 6 shows a SEM image obtained by observing longitudinal sections of the base material and the lower layer in a state in which only the lower layer is formed on the base material.

FIG. 7 shows a SEM image of a longitudinal section when only a collection layer of alumina is formed on the base material.

FIG. 8 is a flowchart showing the production of the porous complex.

FIG. 9 is a diagram showing a configuration of a dry deposition device.

FIG. 10 is a diagram for describing a state in which silica gel particles are deposited on the base material.

FIG. 11 is a diagram for describing a mean membrane thickness.

FIG. 12 is a simplified diagram of an algae collector that includes the porous complex.

FIG. 13 is a diagram showing a section of the porous complex.

FIG. 14 is a simplified diagram of enlarged longitudinal sections of the base material and a surface layer.

FIG. 15 is a diagram showing a state in which fine algal particles are deposited.

FIG. 16 is a flowchart showing the production of the porous complex.

FIG. 17 is a simplified diagram of a longitudinal section of a network structure.

FIG. 18 is a flowchart showing the production of the network structure.

### DETAILED DESCRIPTION

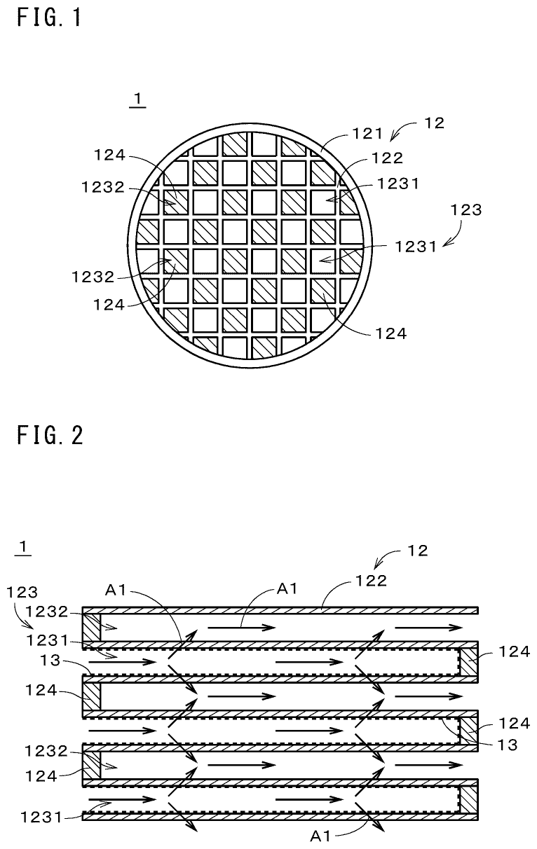

FIG. 1 is a plan view showing a porous complex 1 according to one embodiment of the present invention in simplified form. The porous complex 1 is a tubular member that is long in one direction, and FIG. 1 shows the end face of the porous complex 1 on one side in the longitudinal direction. FIG. 2 is a sectional view showing part of the porous complex 1. FIG. 2 shows part of a section along the longitudinal direction, and the direction perpendicular to the plane of the drawing of FIG. 1 corresponds to the right-and-left direction in FIG. 2. For example, the porous complex 1 is used as a gasoline particulate filter (GPF) that collects particulate matter (i.e., fine particles) such as soot in an exhaust gas exhausted from a gasoline engine of an automobile or the like.

The porous complex 1 includes a porous base material 12 and a porous collection layer 13 (see FIG. 2). In the example shown in FIGS. 1 and 2, the base material 12 is a member having a honeycomb structure. The base material 12 includes a tubular outer wall 121 and a partition wall 122. The tubular outer wall 121 is a tubular portion that extends in the longitudinal direction (i.e., the right-and-left direction in FIG. 2). The tubular outer wall 121 has, for example, an approximately circular sectional shape perpendicular to the longitudinal direction. This sectional shape may be any other shape such as a polygonal shape.

The partition wall 122 is a gird portion that is provided in the interior of the tubular outer wall 121 and partitions the interior into a plurality of cells. As will be described later, these cells include a plurality of first cells 1231 and a plurality of second cells 1232. In the following description, when there is no need to distinguish between the first cells 1231 and the second cells 1232, the first cells 1231 and the second cells 1232 are simply referred to as “cells 123”. Each of the cells 123 serves as a space that extends in the longitudinal direction. Each cell 123 has, for example, an approximately square sectional shape perpendicular to the longitudinal direction.

This sectional shape may be any other shape such as a polygonal shape or a circular shape. The cells 123 have, as a general rule, the same sectional shape. Alternatively, the cells 123 may include cells 123 that have different sectional shapes. The base material 12 is a cell structure whose interior is partitioned into the cells 123 by the partition wall 122.

The tubular outer wall 121 and the partition wall 122 are each a porous part. For example, the tubular outer wall 121 and the partition wall 122 are formed of ceramic such as cordierite. The materials for the tubular outer wall 121 and the partition wall 122 may also be ceramic other than cordierite, or may be a different material other than ceramic.

The longitudinal length of the tubular outer wall 121 is, for example, greater than or equal to 50 mm and less than or equal to 300 mm. The outside diameter of the tubular outer wall 121 is, for example, greater than or equal to 50 mm and less than or equal to 300 mm. The thickness of the tubular outer wall 121 is, for example, greater than or equal to 30 μm and preferably greater than or equal to 50 μm. The thickness of the tubular outer wall 121 is, for example, less than or equal to 1000 μm, preferably less than or equal to 500 μm, and more preferably less than or equal to 350 μm. The longitudinal length of the partition wall 122 is approximately the same as that of the tubular outer wall 121. The thickness of the partition wall 122 is, for example, greater than or equal to 30 μm and preferably greater than or equal to 50 μm. The thickness of the partition wall 122 is, for example, less than or equal to 1000 μm, preferably less than or equal to 500 μm, and more preferably less than or equal to 350 μm.

The porosity of the base material 12 including the tubular outer wall 121 and the partition wall 122 is, for example, higher than or equal to 20% and preferably higher than or equal to 30%. The porosity of the base material 12 is, for example, lower than or equal to 80% and preferably lower than or equal to 70%. The open porosity of the base material 12 is, for example, higher than or equal to 40% and preferably higher than or equal to 55%. The open porosity of the base material 12 is, for example, lower than or equal to 65%. The porosity and open porosity of the base material 12 can be measured by the Archimedes method.

The mean pore diameter (an arithmetical mean value obtained by dividing a total value of the diameters of all pores by the number of pores, or a value equivalent thereto; the same applies below) of the base material 12 is, for example, greater than or equal to 10 μm and preferably greater than or equal to 12 μm. The mean pore diameter of the base material 12 is, for example, less than or equal to 30 μm and preferably less than or equal to 25 μm. The mean pore diameter can be measured by a mercury porosimeter. The open area ratio of the surface of the base material 12 is, for example, higher than or equal to 20% and preferably higher than or equal to 25%. The open area ratio of the surface of the base material 12 is, for example, lower than or equal to 60% and preferably lower than or equal to 50%. The open area ratio of the surface refers to the proportion of the area of a region where pores are open in the surface of the base material 12 and can be obtained by image analysis of an SEM (scanning electron microscope) image of this surface. The SEM image is captured at, for example, 500× magnification. The image analysis may be conducted using, for example, image analysis software “Image-Pro ver. 9.3.2” developed by Nippon Roper K. K.

The cell density (i.e., the number of cells 123 per unit area of a section perpendicular to the longitudinal direction) of the base material 12 is, for example, higher than or equal to 10 cells/cm², preferably higher than or equal to 20 cells/cm², and more preferably higher than or equal to 30 cells/cm². This cell density is, for example, lower than or equal to 200 cells/cm² and preferably lower than or equal to 150 cells/cm². In FIG. 1, the cells 123 are illustrated larger than their actual size and smaller in number than their actual number. Features of the cells 123 such as size and number may be modified in various ways.

In the case where the porous complex 1 is used as a GPF, a gas such as an exhaust gas flows through the inside of the porous complex 1, with one longitudinal end side of the porous complex 1 (i.e., the left side in FIG. 2) serving as an inlet and the other longitudinal end side thereof as an outlet. Among the cells 123 of the porous complex 1, some cells 123 have a mesh sealing part 124 at their end on the inlet side, and the remaining cells 123 have a mesh sealing part 124 at their end on the outlet side.

FIG. 1 illustrates the inlet side of the porous complex 1. To facilitate understanding of the drawing, the mesh sealing parts 124 on the inlet side in FIG. 1 are cross-hatched in FIG. 1. In the example shown in FIG. 1, the cells 123 that have the mesh sealing part 124 on the inlet side and the cells 123 that do not have the mesh sealing part 124 on the inlet side (i.e., the cells 123 that have the mesh sealing part 124 on the outlet side) are alternately aligned in both the horizontal and vertical directions in FIG. 1.

The first cells 1231 are cells 123 that have the mesh sealing part 124 on the outlet side. The second cells 1232 are cells 123 that have the mesh sealing part 124 on the inlet side. In the porous complex 1, the first cells 1231 sealed at one longitudinal end and the second cells 1232 sealed at the other longitudinal end are arranged alternately.

The collection layer 13 is formed on the base material 12. In the example shown in FIG. 2, the collection layer 13 is provided in the first cells 1231 having the mesh sealing part 124 on the outlet side, and covers the inner surfaces of the first cells 1231 (i.e., the surface of the partition wall 122). The collection layer 13 is indicated by thick broken lines in FIG. 2. The collection layer 13 may also be provided on the inner surfaces of the mesh sealing parts 124 on the outlet side of the first cells 1231. On the other hand, the collection layer 13 does not exist in the second cells 1232 having the mesh sealing part 124 on the inlet side. In other words, the inner surfaces of the second cells 1232 are exposed without being covered with the collection layer 13.

In the porous complex 1 shown in FIGS. 1 and 2, as indicated by arrows A1 in FIG. 2, a gas introduced in the porous complex 1 flows into the first cells 1231 from the inlets of the first cells 1231 whose inlet side is not sealed, and flows from the first cells 1231 through the porous collection layer 13 and the porous partition wall 122 into the second cells 1232 whose outlet side is not sealed. At this time, the collection layer 13 efficiently collects substances (here, particulate matter) that are contained in the gas and to be collected. In the case where the collection layer 13 contains catalyst particles described later, combustion of the collected particulate matter (i.e., oxidation removal) is accelerated. In the following description, the inner surfaces of the first cells 1231 provided with the collection layer 13 are also referred to as “collection surfaces”.

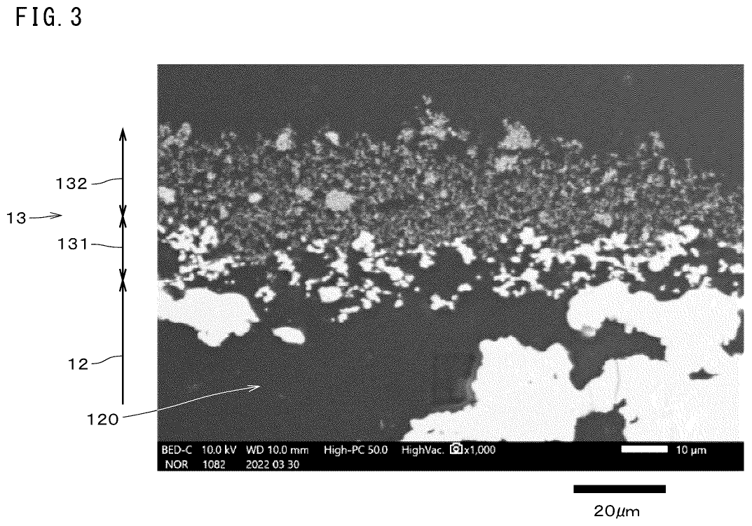

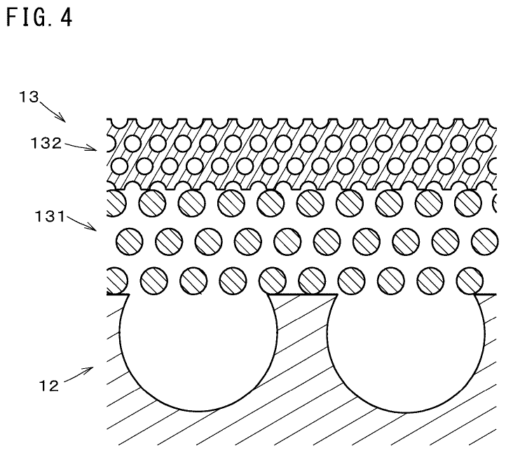

FIG. 3 shows a SEM image of a longitudinal section of the porous complex 1 provided with the collection layer 3, and FIG. 4 is a simplified diagram of the structure shown in FIG. 3. The “longitudinal section” refers to a plane perpendicular to the surface of the base material 12, and FIGS. 3 and 4 show the longitudinal section parallel to the longitudinal direction of the cells 123. In FIG. 3, the range indicated by a reference sign 12 refers to the range of the base material 12, the range indicated by a reference sign 131 in which fine white dots exist refers to the range of a lower layer 131 of the collection layer 13, and the range of a gray area indicated by a reference sign 132 refers to the range of an upper layer 132 of the collection layer 13.

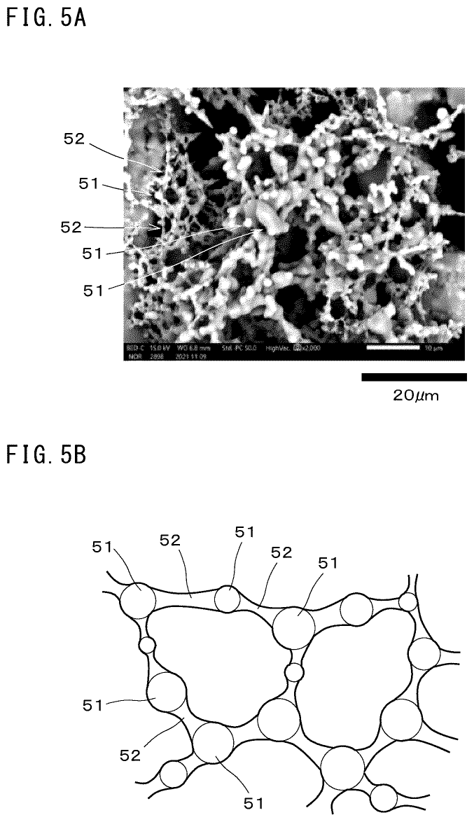

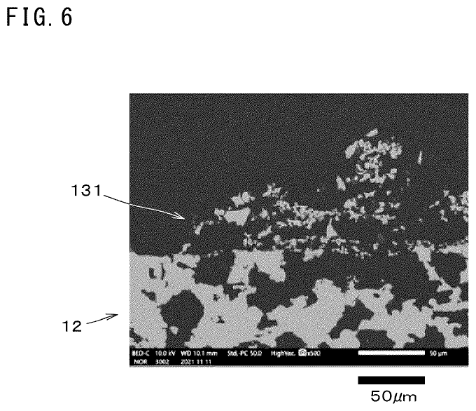

The base material 12 has large pores that are connected together to provide air permeability. The lower layer 131 is formed on the base material 12. The upper layer 132 is formed on the lower layer 131. FIG. 5A shows a SEM image obtained by preparing a porous complex that includes only the lower layer 131 formed on the base material 12 and observing the lower layer 131 from a direction perpendicular to the surface of the base material 12. FIG. 5B is a simplified diagram of the structure shown in FIG. 5A. FIG. 6 shows a SEM image obtained by observing a longitudinal section of the porous complex that includes only the lower layer 131 formed on the base material 12.

As shown in FIGS. 5A and 5B, the lower layer 131 has a three-dimensional mesh-like structure having air permeability. The lower layer 131 is a network structure having a novel structure. The three-dimensional mesh-like structure is a structure in which silica (SiO₂) continuums including connected granular portions 51 are further connected together in three-dimensional mesh form. In other words, the network structure formed of silica includes a plurality of granular portions 51 formed of silica and a plurality of joining portions 52 formed of silica and connecting the granular portions 51 to form a three-dimensional mesh-connected continuum together with the granular portions 51. The joining portions 52 have a constricted shape between the granular portions 51. This structure is formed by densifying and bonding silica gel (SiO₂·nH₂O) particles by firing (so-called a baking process) as will be described later.

Since the lower layer 131 has a mesh-like structure, when observed only in the brightest area, the lower layer 131 appears as a scattering of small dots as shown in the sectional views of FIGS. 3 and 6. Note that in the case where a bright image is captured and observed including gray areas, the lower layer can be recognized as a network structure. The upper layer 132 is alumina (Al₂O₃). The upper layer is porous and has air permeability, and is formed by firing alumina particles.

The mean pore diameter of the upper layer 132 is smaller than the mean pore diameter of the lower layer 131. The mean pore diameter of the lower layer 131 is smaller than the mean pore diameter of the base material 12. Since the base material 12, the lower layer 131, and the upper layer 132 all have air permeability, the porous complex 1 also has air permeability.

In FIG. 4, sections of large pores of the base material 12 are indicated as large cavities, a section of the mesh-like structure of the lower layer 131 is shown with a large number of circles, and small pores of the upper layer 132 are expressed as a large number of small cavities. The surface of the upper layer 132 corresponds to the surface of the porous complex 1.

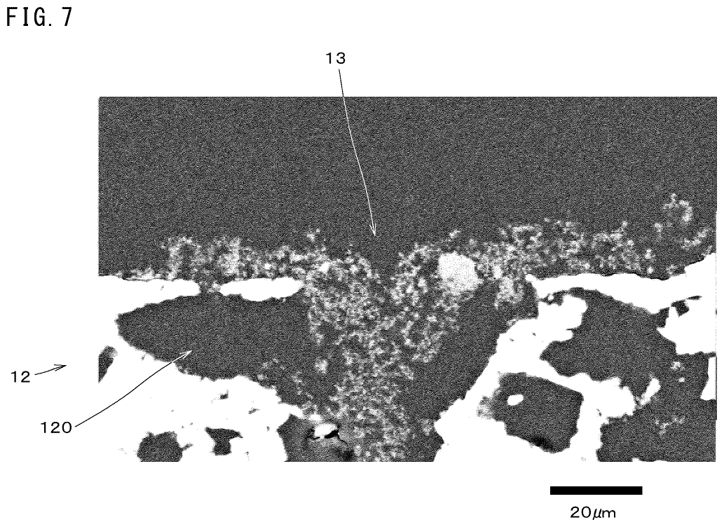

FIG. 7 shows a SEM image of a longitudinal section when the collection layer 13 formed of only alumina is formed on the base material 12 without forming the lower layer 131. A comparison between FIG. 3 and FIG. 7 shows that in FIG. 3, the mesh-like lower layer 131 covers the openings of pores 120 of the base material 12 so as to support the upper layer 132 of alumina, whereas in FIG. 7, the collection layer 13 formed of only alumina penetrates into the pores 120 of the base material 12. Conventionally, in order to improve collection efficiency, it was necessary to reduce the size of material particles for the collection layer, but in this case, the material particles will penetrate into the pores 120 as shown in FIG. 7, resulting in a significant increase in pressure loss. In contrast, in the case of FIG. 3, even if the material particles for the upper layer 132 are made small, these particles will not penetrate into the pores 120, and therefore sufficient collection efficiency can be achieved while suppressing an increase in pressure loss.

The upper layer 132 of the collection layer 13 may include catalyst particles for accelerating oxidation removal from collected substances. For example, the catalyst particles become part of the upper layer 132 by being attached to the upper layer 132 and subjected to baking. The aforementioned catalyst particles are typically an oxide and they are preferably CeO₂ (ceria), a lanthanum (La)-cerium (Ce) composite oxide, a lanthanum-manganese (Mn)-cerium composite oxide, a lanthanum-cobalt (Co)-cerium composite oxide, a lanthanum-iron (Fe)-cerium composite oxide, or a lanthanum-praseodymium (Pr)-cerium composite oxide. In other words, the particles of the collection layer 13 preferably contain at least one type of CeO₂, a lanthanum-cerium composite oxide, a lanthanum-manganese-cerium composite oxide, a lanthanum-cobalt-cerium composite oxide, a lanthanum-iron-cerium composite oxide, and a lanthanum-praseodymium-cerium composite oxide.

The lanthanum-cerium composite oxide is an oxide that contains La and Ce and also written as “La-Ce-O”. The lanthanum-manganese-cerium composite oxide is an oxide that contains La, Mn, and Ce and also written as “La-Mn-Ce-O”. The lanthanum-cobalt-cerium composite oxide is an oxide that contains La, Co, and Ce and also written as “La-Co-Ce-O”. The lanthanum-iron-cerium composite oxide is an oxide that contains La, Fe, and Ce and also written as “La-Fe-Ce-O”. The lanthanum-praseodymium-cerium composite oxide is an oxide that contains La, Pr, and Ce and also written as “La-Pr-Ce-O”.

Particles of the aforementioned composite oxides are produced by, for example, a citric acid method. The particles of the composite oxides may also be produced by any other method such as an impregnation supporting method or a complex polymerization method.

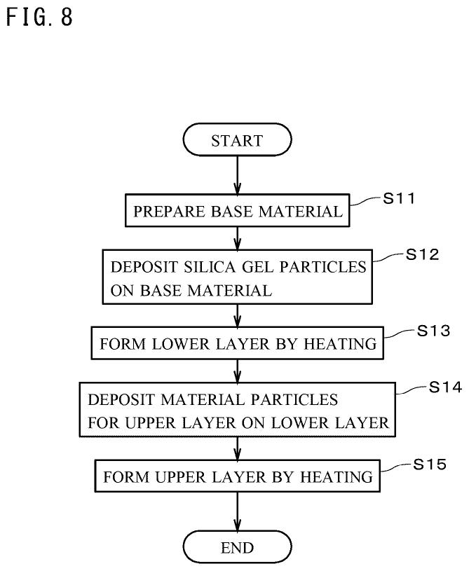

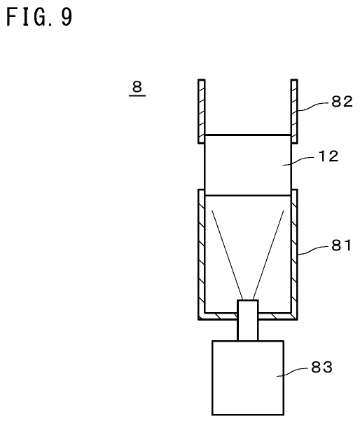

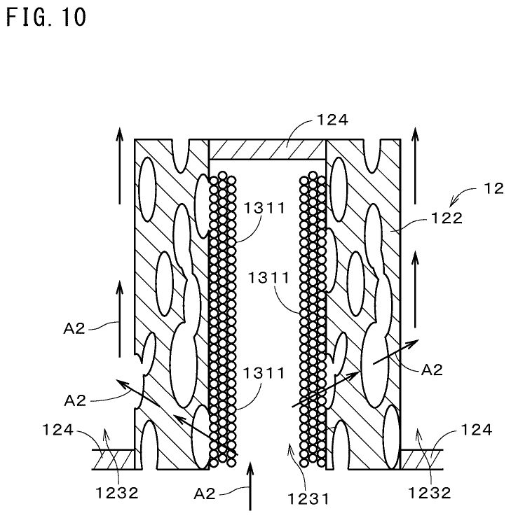

Next, one example of the production of the porous complex 1 will be described. FIG. 8 is a flowchart showing the production of the porous complex 1. Firstly, a porous sintered body having air permeability is prepared as the base material 12 (step S11). Any of various known methods may be used as the method of producing the base material 12. Then, a step of depositing silica gel particles on the base material 12 by a dry deposition method is performed (step S12). Accordingly, aggregates of the silica gel particles are formed on the base material 12. FIG. 9 is a diagram showing a configuration of a dry deposition device 8. FIG. 10 is a diagram for describing a state in which silica gel particles are deposited on the base material 12, and shows part of a longitudinal section of the base material 12 in schematic form.

The dry deposition device 8 shown in FIG. 9 includes a first tubular portion 81, a second tubular portion 82, and a particle supplier 83. The first tubular portion 81 and the second tubular portion 82 are both tubular members, and their sectional shape perpendicular to their central axis is approximately the same as the sectional shape of the outer surface of the base material 12 (the outer surface of the tubular outer wall 121). As described previously, the base material 12 is a member that extends in the longitudinal direction, so that one longitudinal end of the base material 12 is inserted in the end of the first tubular portion 81, and the other end of the base material 12 is inserted in the end of the second tubular portion 82. In the present embodiment, the end of the base material 12 at which the first cells 1231 (see FIG. 10) are open (actually the first cells 1231 before formation of the lower layer 131) (i.e., the end at which the second cells 1232 (actually the second cells 1232 before formation of the lower layer 131) having their mesh sealing part 124) is inserted in the first tubular portion 81, and the end of the base material 12 at which the second cells 1232 are open is inserted in the second tubular portion 82. The outer surface of the base material 12 may come in contact with the first tubular portion 81 or the second tubular portion 82 via an O-ring or the like. Passage of gases and liquids is almost impossible between the outer surface of the base material 12 and the inner surface of the first tubular portion 81 and between the outer surface of the base material 12 and the inner surface of the second tubular portion 82.

The other end of the first tubular portion 81 on the side opposite to the base material 12 is connected to the particle supplier 83. The particle supplier 83 supplies an aerosol into the first tubular portion 81, the aerosol containing silica gel particles dispersing in a gas. A dispersion medium of the aerosol is, for example, air. The dispersion medium of the aerosol may also be a gas other than air. The other end of the second tubular portion 82 on the side opposite to the base material 12 is connected to a pressure-reducing mechanism which is not shown, so as to reduce pressure inside the second tubular portion 82. This allows the aerosol supplied into the first tubular portion 81 to flow into the base material 12.

As indicated by arrows A2 in FIG. 10, the aerosol flows into the first cells 1231. The gas contained in the aerosol penetrates into the partition wall 122 from pores that are open in the inner surfaces of the first cells 1231, and flows into the second cells 1232 adjacent to the first cells 1231. The gas flowing into the second cells 1232 is exhausted to the outside of the base material 12 through the openings of the second cells 1232. Accordingly, the silica gel particles 1311 are deposited on the inner surfaces of the first cells 1231. At this time, since the silica gel particles 1311 have a low specific gravity, most of the silica gel particles 1311 will not penetrate into the pores of the inner surfaces. The silica gel particles 1311 preferably have a mean particle diameter of greater than or equal to 0.1 μm and less than or equal to 5.0 μm. The mean particle diameter refers to an arithmetical mean value (an arithmetical mean value obtained by dividing a total value of the diameters of particles by the number of particles, or a value equivalent thereto (e.g., D50); the same applies below), and is obtained from the particle size distribution of particles obtained by a laser diffraction method.

Preferably, the density of the silica gel particles in the aerosol is higher than or equal to 1.0 g/cm³ and lower than or equal to 2.2 g/cm³, and the rate of suction of the aerosol is higher than or equal to 10 L/(min/cm²) and lower than or equal to 20 L/(min/cm²) (“L” represents the liter). A sedimentary layer of the silica gel particles preferably has a thickness of greater than or equal to 20 μm and less than or equal to 50 μm. The thickness of the sedimentary layer is obtained as a difference between a mean place of the surface heights of the sedimentary layer and a mean place of the surface heights of the base material, which are measured by a three-dimensional shape measuring device using laser.

The base material 12 with the silica gel particles deposited thereon is taken out of the dry deposition device 8 and subjected to firing (step S13). Accordingly, the aggregates of the silica gel particles are heated and sintered in the form of a network structure. The heating temperature during firing is preferably higher than or equal to 1200° C. and lower than or equal to 1400° C. The heating time during firing is preferably 0.5 hours or more and two hours or less. The rate of a temperature rise during firing is higher than or equal to 50° C./hour and lower than or equal to 100° C./hour. This firing produces the lower layer 131 of the collection layer 13 on the base material 12.

Next, a step of depositing upper-layer material particles on the lower layer 131 is performed by a dry deposition method (step S14). The deposition of the upper-layer material particles is performed by a dry deposition device according to the deposition of the silica gel particles described with reference to FIG. 9.

The upper-layer material particles are preferably alumina particles. The upper-layer material particles may also be different particles other than alumina particles, and may be silicon carbide (SiC) particles, cordierite (2MgO·2Al₂O₃·5SiO₂) particles, or mullite (3Al₂O₃·2SiO₂) particles or the like. A mean particle diameter of the upper-layer material particles is preferably greater than or equal to 0.05 μm and less than or equal to 1.0 μm. Preferably, the density of the particle of the material for the upper layer in the aerosol is higher than or equal to 2.5 g/cm³ and lower than or equal to 4.0 g/cm³, and the rate of suction of the aerosol is higher than or equal to 10 L/(min/cm²) and lower than or equal to 15 L/(min/cm²). A sedimentary layer of the upper-layer material particles preferably has a thickness of greater than or equal to 15 μm and less than or equal to 40 μm.

A porous complex with the upper-layer material particles deposited thereon is taken out of the dry deposition device and subjected again to firing (step S15). In the case where the upper-layer material particles are alumina particles, the heating temperature during firing is preferably higher than or equal to 900° C. and lower than or equal to 1500° C. The heating time during firing is preferably 0.5 hours or more and two hours or less. Through this firing, the upper layer 132 is formed on the lower layer 131 formed on the base material 12. Accordingly, the collection layer 13 including the lower layer 131 and the upper layer 132 is formed, and the porous complex 1 is obtained.

Next, Examples 1-1 to 1-6 of the porous complex according to the present invention and Comparative Examples 1-1 to 1-4 for comparison with the above porous complex will be described with reference to Tables 1 and 2.

TABLE 1

| | | Base Material | | | Lower-Layer Forming Conditions | | | | |
|---|---|---|---|---|---|---|---|---|---|
| | | | | Mean | | Mean | | | |
| | | | | Pore | | Pore | Pore | Suction | Firing |
| | | | Porosity | Diameter | | Diameter | Volume | Displacement | Temperature |
| | | Material | % | μm | Material | μm | cm³/g | L/(min · cm²) | ° C. |
| Example | 1-1 | Cordierite | 48 | 12 | Silica Gel | 4 | 1.5 | 13.7 | 1240 |
| Example | 1-2 | Cordierite | 48 | 12 | Silica Gel | 4 | 1.5 | 13.7 | 1240 |
| Example | 1-3 | Cordierite | 48 | 12 | Silica Gel | 4 | 1.5 | 13.7 | 1240 |
| Example | 1-4 | Cordierite | 48 | 12 | Silica Gel | 4 | 1.5 | 13.7 | 1240 |
| Example | 1-5 | Cordierite | 48 | 12 | Silica Gel | 0.3 | 1 | 13.7 | 1240 |
| Example | 1-6 | Cordierite | 48 | 12 | Silica Gel | 0.3 | 1 | 13.7 | 1240 |
| Comparative | 1-1 | Cordierite | 48 | 12 | Silica Gel | 4 | 1.5 | 13.7 | 1240 |
| Example | | | | | | | | | |
| Comparative | 1-2 | Cordierite | 48 | 12 | Al₂O₃ | 0.1 | — | 11.0 | 1100 |
| Example | | | | | | | | | |
| Comparative | 1-3 | Cordierite | 48 | 12 | None | — | — | — | — |
| Example | | | | | | | | | |
| Comparative | 1-4 | Cordierite | 55 | 9 | None | — | — | — | — |
| Example | | | | | | | | | |

| | | Lower-Layer Forming | Upper-Layer Forming Conditions | | | | |
|---|---|---|---|---|---|---|---|
| | | Conditions | | Mean | | | |
| | | Firing | | Pore | Suction | Firing | Firing |
| | | Time | | Diameter | Displacement | Temperature | Time |
| | | h | Material | μm | L/(min · cm²) | ° C. | h |
| Example | 1-1 | 2.0 | Al₂O₃ | 0.1 | 13.7 | 1100 | 1.5 |
| Example | 1-2 | 2.0 | Al₂O₃ | 0.1 | 13.7 | 1100 | 1.5 |
| Example | 1-3 | 2.0 | Al₂O₃ | 0.1 | 13.7 | 1100 | 1.5 |
| Example | 1-4 | 2.0 | Al₂O₃ | 0.1 | 11.0 | 1100 | 1.5 |
| Example | 1-5 | 2.0 | Al₂O₃ | 0.1 | 13.7 | 1100 | 1.5 |
| Example | 1-6 | 2.0 | Al₂O₃ | 0.1 | 11.0 | 1100 | 1.5 |
| Comparative | 1-1 | 2.0 | None | — | — | — | — |
| Example | | | | | | | |
| Comparative | 1-2 | 2.0 | None | — | — | — | — |
| Example | | | | | | | |
| Comparative | 1-3 | — | None | — | — | — | — |
| Example | | | | | | | |
| Comparative | 1-4 | — | None | — | — | — | — |
| Example | | | | | | | |

TABLE 2

| | | Lower Layer | | | | | | |
|---|---|---|---|---|---|---|---|---|
| | | | | | | | Membrane Surface | |
| | | | Section Information | | | | Information | |
| | | | Penetration | | Mean | Mean | | Mean |
| | | | Depth into | | Pore | Membrane | | Pore |
| | | | Base Material | Porosity | Diameter | Thickness | Porosity | Diameter |
| | | Material | μm | % | μm | μm | % | μm |
| Example | 1-1 | SiO₂ | 0 | 68 | 4.5 | 20 | 45 | 3.9 |
| Example | 1-2 | SiO₂ | 0 | 69 | 4.7 | 20 | 46 | 3.5 |
| Example | 1-3 | SiO₂ | 0 | 69 | 4.7 | 18 | 46 | 3.3 |
| Example | 1-4 | SiO₂ | 0 | 68 | 4.5 | 25 | 45 | 3.0 |
| Example | 1-5 | SiO₂ | 0 | 67 | 3.8 | 20 | 40 | 2.8 |
| Example | 1-6 | SiO₂ | 0 | 68 | 3.8 | 24 | 40 | 2.8 |
| Comparative | 1-1 | SiO₂ | 0 | 69 | 4.7 | 20 | 46 | 3.3 |
| Example | | | | | | | | |
| Comparative | 1-2 | Al₂O₃ | 20 | 88 | 1.2 | 40 | — | — |
| Example | | | | | | | | |
| Comparative | 1-3 | None | — | — | — | — | — | — |
| Example | | | | | | | | |
| Comparative | 1-4 | None | — | — | — | — | — | — |
| Example | | | | | | | | |

| | | Lower Layer | | | | | | |
|---|---|---|---|---|---|---|---|---|
| | | Mean | | | | | | Rate of |
| | | Diameter of | Upper Layer | | | | | Rise in |
| | | Granular | | | Mean | Mean | | Initial |
| | | Portions of | | | Pore | Membrane | Collection | Pressure |
| | | Lower Layer | | Porosity | Diameter | Thickness | Efficiency | Loss |
| | | μm | Material | % | μm | μm | % | % |
| Example | 1-1 | 3.0 | Al₂O₃ | 88 | 1.3 | 15 | 99.3 | 15 |
| Example | 1-2 | 3.3 | Al₂O₃ | 86 | 1.3 | 20 | 99.5 | 18 |
| Example | 1-3 | 3.2 | Al₂O₃ | 86 | 1.2 | 25 | 99.6 | 25 |
| Example | 1-4 | 3.0 | Al₂O₃ | 88 | 1.2 | 40 | 99.9 | 39 |
| Example | 1-5 | 1.0 | Al₂O₃ | 86 | 1.2 | 25 | 99.6 | 25 |
| Example | 1-6 | 1.2 | Al₂O₃ | 88 | 1.2 | 40 | 99.9 | 39 |
| Comparative | 1-1 | 0.9 | None | — | — | — | 44.0 | 8 |
| Example | | | | | | | | |
| Comparative | 1-2 | — | None | — | — | — | 99.8 | 80 |
| Example | | | | | | | | |
| Comparative | 1-3 | — | None | — | — | — | 45.0 | 0 |
| Example | | | | | | | | |
| Comparative | 1-4 | — | None | — | — | — | 75.0 | 10 |
| Example | | | | | | | | |

### Example 1-1

In Example 1-1, firstly, a base material formed of cordierite and having a honeycomb filter shape (honeycomb structure) was prepared. The base material had a porosity of 48% and a mean pore diameter of 12 μm (an arithmetical mean value obtained by dividing a total value of the diameters of all pores by the number of pores, or a value equivalent thereto; the same applies below). The porosity was measured by the Archimedes method using deionized water as a medium. The mean pore diameter was measured by a mercury porosimeter.

Silica gel particles with a mean particle diameter of 4 μm and a pore volume of 1.5 cm³/g were deposited on the base material of cordierite by a dry deposition method. During the deposition, suction was conducted at 13.7 L/(min cm²) (the amount of suction per unit time of one minute and per unit surface area of 1 cm² in the first cells 1231 of the base material 12). Thereafter, firing was conducted at a temperature of 1240° C. for two hours so as to form a lower layer of a collection layer.

Then, alumina particles with a mean particle diameter of 0.1 μm were deposited on the lower layer by a dry deposition method. During the deposition, suction was conducted at 13.7 L/(min·cm²). Thereafter, firing was conducted at a temperature of 1100° C. for 1.5 hours so as to form an upper layer of the collection layer.

In the produced porous complex, the penetration depth of the collection layer into the pores of the base material in a longitudinal section of the lower layer of silica, i.e., in a section of the porous complex along a plane perpendicular to the surface of the base material, was 0 μm. In the longitudinal section, the lower layer had a porosity of 68%, a mean pore diameter of 4.5 μm, and a mean membrane thickness (i.e., a mean layer thickness) of 20 μm.

These measured values were obtained from a 1000× scanning electron microscope (SEM) image acquired by embedding a fragment of the porous complex in a resin and subjecting a section of the fragment to mirror polishing. Specifically, the “penetration depth of the collection layer into the pores of the base material” was obtained by drawing a curve that was assumed to be the surface of the base material in the SEM image, acquiring a straight line that best fitted this curve by, for example, the least squares method, and obtaining a mean penetration depth of the collection layer (the lower layer if there are upper and lower layers) into the pores with respect to this straight line. “The porosity of the lower layer in the longitudinal section” was obtained by image analysis of the SEM image using Image-Pro described above. This image analysis was conducted by, for example, a technique similar to that used in WO/2020/194681 described above. Specifically, in a region of the SEM image where the lower layer exists, the areas of bright regions where bright portions (i.e., particles of the lower layer) appeared and the areas of dark regions where dark portions (i.e., pores of the lower layer) appeared were calculated. Then, a total area of the dark regions was divided by a sum of a total area of the bright regions and the total area of the dark regions to calculate the porosity of the lower layer.

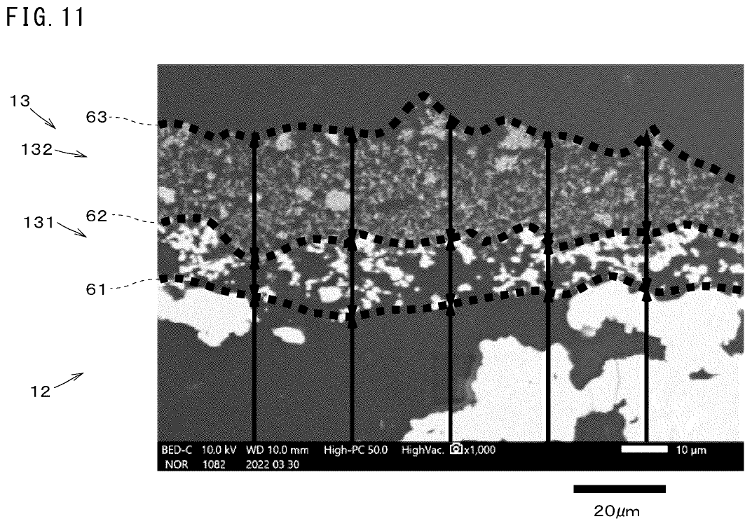

“The mean pore diameter of the lower layer in the longitudinal section” was obtained by binarizing the SEM image by Image-Pro using a threshold value that allowed the skeleton of the network structure and the sections of pores to be distinguished, acquiring the contours of a large number of pores from this image, and calculating an arithmetical mean value of the widths of portions that connected the pores. As shown in FIG. 11, the mean membrane thickness was obtained by acquiring a curve 61 that followed the boundary between the surface of the base material 12 and the lower layer 131 and a curve 62 that followed the boundary between the lower layer 131 and the upper layer 132, and obtaining an arithmetical mean value of the distances between the two curves 61 and 62 measured on straight lines that divided the image into six equal parts in the right-and-left direction. Note that the right-and-left direction of the image referred to the direction along the surface of the base material 12.

In a membrane surface of the lower layer, i.e., in a plane parallel to the surface of the base material (hereinafter, referred to as “in the membrane surface”), the lower layer had a porosity of 45% and a mean pore diameter of 3.9 μm, and the mean diameter of the granular portions was 3.0 μm. These measured values were obtained from a 1000× SEM image acquired by embedding a fragment of the porous complex in a resin and polishing the fragment from the upper layer side to remove the upper layer and obtain a mirror-finished transverse section of the lower layer.

Specifically, “the porosity of the lower layer in the membrane surface” was obtained from the SEM image by a technique using Image-Pro described above, similar to the technique used for the longitudinal section. “The mean pore diameter of the lower layer in the membrane surface” was obtained by binarizing the SEM image by Image-Pro using a threshold value that allowed the skeleton of the network structure and the sections of pores to be distinguished, and acquiring an arithmetical mean value of the major axis of ellipses that best fitted the contours of a large number of pores from the SEM image in the same manner as in the case of the longitudinal section. The “mean diameter of the granular portions” was obtained by binarizing a 2000× SEM image by Image-Pro using a threshold value that allowed the skeleton of the network structure and the sections of pores to be distinguished, determining the contour of the skeleton, acquiring ellipses along granular portions that were recognized as approximately circular in the skeleton (ellipses with the smaller different areas with respect to portions other than those that joined adjacent granular portions), and obtaining an arithmetical mean value of the major axes of these ellipses.

In the longitudinal section, the upper layer of alumina had a porosity of 88%, a mean pore diameter of 1.3 μm, and a mean membrane thickness of 15 μm.

These measured values were obtained from a 1000× SEM image acquired by embedding a fragment of the porous complex in a resin and subjecting a polished section to mirror polishing. Specifically, “the porosity of the upper layer in the longitudinal section” was acquired from the SEM image by a technique using Image-Pro described above, similar to the technique used for the lower layer. “The mean pore diameter of the upper layer in the longitudinal section” was obtained by binarizing the SEM image by Image-Pro using a threshold value that allowed the skeleton of the network structure and the sections of pores to be distinguished, acquiring the contours of a large number of pores from this image, and obtaining an arithmetical mean value of the widths of portions that connect the pores. As shown in FIG. 11, the mean membrane thickness was obtained by acquiring the curve 62 that followed the boundary between the lower layer 131 and the upper layer 132 and a curve 63 that followed the surface of the upper layer 132, and obtaining an arithmetical mean value of the distances between the two curves 62 and 63 measured on straight lines that divided the image into six equal parts in the right-and-left direction. In the various measurements, the sample did not necessarily have to be embedded in a resin, and similar observations and measurements were also possible even if the sample was not embedded in a resin.

The methods of acquiring the above-described measured values for the base material, the lower layer, and the upper layer were also applied to the examples and the comparative examples described below.

In Example 1-1, the collection efficiency of the porous complex was 99.3%, and the rate of rise in initial pressure loss was 15%.

The collection efficiency of the porous complex was obtained as follows. Firstly, the porous complex was mounted as a GPF on an exhaust system of a passenger vehicle that included a 2-liter direct injection gasoline engine, and a chassis dynamometer vehicle test was conducted. In the vehicle test, the number of exhausted pieces of particulate matter contained in an exhaust gas during driving in a driving mode of Europe regulations (RTS95) was measured by a measurement method according to the PMP (particulate measurement protocol of European regulations). A similar vehicle test was also conducted without a GPF mounted on the aforementioned exhaust system, and the number of exhausted pieces of particulate matter contained in an exhaust gas was measured by a similar measurement method. With the number of exhausted pieces of particulate matter without a GPF assumed as a “reference number of exhausted pieces”, “collection efficiency (%)” was defined as a value (%) obtained by dividing a difference between the number of exhausted pieces of particulate matter measured with the porous complex mounted on the system and the reference number of exhausted pieces, by the reference number of exhausted pieces.

In an assessment on the initial pressure loss of the porous complex, firstly, air at ambient temperature was supplied to the porous complex at a flow rate of 10 Nm³/min, and a pressure difference before and after the supply in the porous complex (i.e., a differential pressure between on air inflow and outflow sides) was measured. Then, the pressure difference in the case where there was only the base material (this case corresponds to Comparative Example 1-3) was taken as a reference pressure difference, and the rate of increase in the aforementioned pressure difference of the porous complex with respect to the reference pressure difference was regarded as the rate of increase in initial pressure loss. This rate of increase (%) in initial pressure loss was obtained from (A−B)/B×100, where A was the aforementioned pressure difference of the porous complex, and B was the reference pressure difference of the base material. The way of obtaining the collection efficiency and the initial pressure loss were the same as in Examples 1-2 to 1-6 and Comparative Examples 1-1 to 1-3 described below. In Comparative Example 1-4 that used a base material different from the base material 12, initial pressure loss was obtained by using, as a reference, the case of Comparative Example 1-3 in which there was only the base material.

### Example 1-2

Conditions for producing the porous complex according to Example 1-2 were the same as in Example 1-1. In the produced porous complex, the penetration depth of the collection layer into the pores of the base material in a longitudinal section of the lower layer of silica was 0 μm. In the longitudinal section, the lower layer had a porosity of 69%, a mean pore diameter of 4.7 μm, and a mean membrane thickness of 20 μm. In the membrane surface, the lower layer had a porosity of 46% and a mean pore diameter of 3.5 μm, and the mean diameter of the granular portions was 3.3 μm. In the longitudinal section, the upper layer of alumina had a porosity of 86%, a mean pore diameter of 1.3 μm, and a mean membrane thickness of 20 μm.

In Example 1-2, the collection efficiency of the porous complex was 99.5%, and the rate of rise in initial pressure loss was 18%.

### Example 1-3

Conditions for producing the porous complex according to Example 1-3 were the same as in Example 1-1. In the produced porous complex, the penetration depth of the collection layer into the pores of the base material in a longitudinal section of the lower layer of silica was 0 μm. In the longitudinal section, the lower layer had a porosity of 69%, a mean pore diameter of 4.7 μm, and a mean membrane thickness of 18 μm. In the membrane surface, the lower layer had a porosity of 4.6% and a mean pore diameter of 3.3 μm, and the mean diameter of the granular portions was 3.2 μm. In the longitudinal section, the upper layer of alumina had a porosity of 86%, a mean pore diameter of 1.2 μm, and a mean membrane thickness of 25 μm.

In Example 1-3, the collection efficiency of the porous complex was 99.6%, and the rate of rise in initial pressure loss was 25%.

### Example 1-4

Conditions for producing the porous complex according to Example 1-4 were the same as in Example 1-1, except that suction was conducted at 11.0 L/(min cm²) during the deposition of the alumina particles serving as the material for the upper layer.

In the produced porous complex, the penetration depth of the collection layer into the pores of the base material in a longitudinal section of the lower layer of silica was 0 μm. In the longitudinal section, the lower layer had a porosity of 68%, a mean pore diameter of 4.5 μm, and a mean membrane thickness of 25 μm. In the membrane surface, the lower layer had a porosity of 45% and a mean pore diameter of 3.0 μm, and the mean diameter of the granular portions was 3.0 μm. In the longitudinal section, the upper layer of alumina had a porosity of 88%, a mean pore diameter of 1.2 μm, and a mean membrane thickness of 40 μm.

In Example 1-4, the collection efficiency of the porous complex was 99.9%, and the rate of rise in initial pressure loss was 39%.

### Example 1-5

Conditions for producing the porous complex according to Example 1-5 were the same as in Example 1-1, except that the silica gel particles serving as the material for the lower layer had a mean particle diameter of 0.3 μm and a pore volume of 1 cm³/g.

In the produced porous complex, the penetration depth of the collection layer into the pores of the base material in a longitudinal section of the lower layer of silica was 0 μm. In the longitudinal section, the lower layer had a porosity of 67%, a mean pore diameter of 3.8 μm, and a mean membrane thickness of 20 μm. In the membrane surface, the lower layer had a porosity of 40% and a mean pore diameter of 2.8 μm, and the mean diameter of the granular portions was 1.0 μm. In the longitudinal section, the upper layer of alumina had a porosity of 86%, a mean pore diameter of 1.2 μm, and a mean membrane thickness of 25 μm.

In Example 1-5, the collection efficiency of the porous complex was 99.6%, and the rate of rise in initial pressure loss was 25%.

### Example 1-6

Conditions for producing the porous complex according to Example 1-6 were the same as in Example 1-4, except that the silica gel particles serving as the material for the lower layer had a mean particle diameter of 0.3 μm and a pore volume of 1 cm³/g. That is, suction was conducted at 11.0 L/(min cm²) during the deposition of the alumina particles serving as the material for the upper layer.

In the produced porous complex, the penetration depth of the collection layer into the pores of the base material in a longitudinal section of the lower layer of silica was 0 μm. In the longitudinal section, the lower layer had a porosity of 68%, a mean pore diameter of 3.8 μm, and a mean membrane thickness of 24 μm. In the membrane surface, the lower layer had a porosity of 40% and a mean pore diameter of 2.8 μm, and the mean diameter of the granular portions was 1.2 μm. In the longitudinal section, the upper layer of alumina had a porosity of 88%, a mean pore diameter of 1.2 μm, and a mean membrane thickness of 40 μm.

In Example 1-6, the collection efficiency of the porous complex was 99.9%, and the rate of rise in initial pressure loss was 39%.

### Comparative Example 1-1

Conditions for producing the porous complex according to Comparative Example 1-1 were such that the lower layer was formed on the base material under the same conditions as in Example 1-1, and no upper layer was formed. That is, the collection layer included only the lower layer.

In the produced porous complex, the penetration depth of the collection layer into the pores of the base material in a longitudinal section of the lower layer of silica was 0 μm. In the longitudinal section, the lower layer had a porosity of 69%, a mean pore diameter of 4.7 μm, and a mean membrane thickness of 20 μm. In the membrane surface, the lower layer had a porosity of 46% and a mean pore diameter of 3.3 μm, and the mean diameter of the granular portions was 0.9 μm.

In Comparative Example 1-1, the collection efficiency of the porous complex was 44.0%, and the rate of rise in initial pressure loss was 8%.

### Comparative Example 1-2

Conditions for producing the porous complex according to Comparative Example 1-2 were such that alumina particles were used as the material for the lower layer, and no upper layer was formed. That is, the collection layer included only the lower layer. The alumina particles with a mean particle diameter of 0.1 μm were deposited on a base material similar to that in Example 1-1 by a dry deposition method. Suction was conducted at 11.0 L/(min cm²) during the deposition. Thereafter, firing was conducted at a temperature of 1100° C. for two hours so as to form the collection layer (the lower layer without the upper layer).

In the produced porous complex, the penetration depth of the lower layer into the pores of the base material in a longitudinal section was 20 μm. In the longitudinal section, the lower layer had a porosity of 88%, a mean pore diameter of 1.2 μm, and a mean membrane thickness of 40 μm.

In Comparative Example 1-2, the collection efficiency of the porous complex was 99.8%, and the rate of rise in initial pressure loss was 80%.

### Comparative Example 1-3

In Comparative Example 1-3, the base material in Example 1-1 itself was used as a target for measurement. That is, the target to be measured in Comparative Example 1-3 was not a porous complex, but a porous sintered body that included no collection layer.

In Comparative Example 1-3, the collection efficiency of the porous body was 45.0%, and the rate of rise in initial pressure loss was 0% because the comparison was made with Comparative Example 1-3 itself.

### Comparative Example 1-4

In Comparative Example 1-4, a base material itself that was different from the base material in Example 1-1 was used as a target for measurement. That is, the target to be measured in Comparative Example 1-4 was not a porous complex, but a porous sintered body that included no collection layer.

A porous body serving as a base material according to Comparative Example 1-4 was formed of cordierite and had a honeycomb filter shape (honeycomb structure). The base material had a porosity of 55% and a mean pore diameter of 9 μm. The methods of measuring the porosity and the mean pore diameter were the same as in Example 1-1.

In Comparative Example 1-4, the collection efficiency of the porous body according to Comparative Example 1-4 was 75.0%, and the rate of rise in initial pressure loss was 10%.

As is clear from the comparisons between the examples and the comparative examples described above, the porous complex 1 is characterized in that the collection layer 13 includes the lower layer 131 formed by firing silica gel particles and the upper layer 132 having a function of collecting particulate matter. The collection efficiency will deteriorate if the upper layer 132 is not formed as in Comparative Example 1-1, and the initial pressure loss will increase if the mesh-like silica lower layer 131 is not formed as in Comparative Example 1-2. Conventionally, it has been thought that a double-layered collection layer would result in high pressure loss. However, by adopting a double-layered structure without being bound by conventional concepts, the porous complex 1 can achieve both maintaining the collection efficiency and reducing the pressure loss. Note that the reduction in initial pressure loss shown in the examples also results in a reduction in pressure loss when particulate matter is collected in the collection layer 13.

The “air permeability” of the porous complex 1 refers to the property of allowing a gas to flow from one surface of the porous complex 1 to the other surface through internal pores when a pressure difference is applied between the one surface of the porous complex 1 and the other surface on the opposite side. Therefore, the base material 12, the lower layer 131, and the upper layer 132 also naturally have air permeability. The base material 12, the lower layer 131, and the upper layer 132 are all porous sintered bodies. The material for the base material 12 is not limited to cordierite and may, for example, be such as Si-bonded SiC, Cd-bonded SiC, Si₃N₄-bonded SiC, silicon carbide, silicon nitride (Si₃N₄), alumina, or mullite. The upper layer 132 is preferably formed of alumina, but the material for the upper layer is not limited to alumina and may be, for example, such as silicon carbide, cordierite, or mullite. However, in order for the collection layer 13 to achieve its function of collecting particulate matter, the upper layer 132 has a smaller mean pore diameter than the base material 12. The mean pore diameter of the base material 12 is preferably greater than or equal to 10 μm and less than or equal to 30 μm. This suppresses the penetration of the lower layer 131 into the pores while maintaining air permeability high enough. On the other hand, in order to collect particulate matter while maintaining air permeability, the mean pore diameter of the upper layer 132 is preferably greater than or equal to 1.0 μm and less than or equal to 1.5 μm. Note that the “mean pore diameter of the upper layer 132” refers to an arithmetical mean value of the diameters of pores of the upper layer 132, or a value equivalent thereto. The same applies the base material 12 and the lower layer 131.

In order for the upper layer 132 to have a smaller mean pore diameter than the base material 12, the upper-layer material particles to be deposited on the lower layer 131 during formation of the upper layer 132 preferably have a mean particle diameter of greater than or equal to 0.05 μm and less than or equal to 1.0 μm.

Moreover, in order to suppress a rise in pressure loss while suppressing deterioration in collection efficiency, the mean membrane thickness of the upper layer 132 is preferably greater than or equal to 15 μm and less than or equal to 40 μm. As can be seen from Examples 1-3 to 1-6 described above, in order to make the collection efficiency higher than or equal to 99.6%, the membrane thickness of the upper layer is preferably greater than or equal to 25 μm and less than or equal to 40 μm.

The lower layer 131 provided on the base material 12 has a characteristic structure in which silica (SiO₂) continuums including the granular portions are connected together in three-dimensional mesh form. The “continuums including the granular portions” refer to a structure in which each granular portion is connected to the other granular portions like a string. Preferably, a plurality of granular portions do not exist densely, and the granular portions may have a thread-like or constricted shape therebetween. Then, each granular portion is connected irregularly to at least one granular portion, thereby forming a three-dimensional network structure.

It is assumed that the structure of the lower layer 131 described above is realized by, after deposition of the silica gel particles on the base material 12, connecting the surfaces of the silica gel particles to the other silica gel particles during firing and densifying the silica gel particles so as to reduce the number of pores of the silica gel particles. As a result, a state is formed where a net is stretched on the base material 12, and the upper layer 132 is formed on this net without contact with the base material 12. Note that silica gel particles with large particle diameters are thought to become the granular portions.

To realize the phenomenon described above, the mean particle diameter of the silica gel particles is preferably greater than or equal to 0.1 μm and less than or equal to 5.0 μm. The mean pore volume of the silica gel particles is preferably higher than or equal to 0.5 ml/g and lower than or equal to 2.0 ml/g (“ml” represents the milliliter). Regarding the heating temperature and the heating time, the silica gel particles are preferably heated at a temperature of higher than or equal to 1200° C. and lower than or equal to 1400° C. for 0.5 hours or more and two hours or less. Then, the mean particle diameter of the silica granular portions after firing is preferably greater than or equal to 0.8 μm and less than or equal to 5 μm. The mean membrane thickness of the lower layer 131 is preferably greater than or equal to 15 μm and less than or equal to 30 μm. This allows the upper layer 132 to be formed separately from the base material 12 and suppresses an increase in pressure loss. In order to achieve such a mean membrane thickness of the lower layer 131, the thickness of the sedimentary layer of the silica gel particles that are deposited on the base material 12 by a dry deposition method during formation of the lower layer 131 is preferably greater than or equal to 20 μm and less than or equal to 50 μm. The thickness of the sedimentary layer refers to a mean value of the thicknesses of the sedimentary layer deposited in a region where the layer is supposed to be deposited.

The “deposition” of the silica gel particles and the upper-layer material particles during formation of the lower layer 131 and the upper layer 132 refers to simply stacking the particles without any binder or the like (however, other particles may be present), and any method other than that using the aforementioned dry deposition device 8 may be adopted for deposition of the particles. For example, the particles may be deposited on the base material 12 by simply using gravity or centrifugal force, or the deposition may be implemented by any other physical force.

Note that the various “preferable” numerical ranges given in the above description do not intend to limit the present invention.

The application of the porous complex 1 is not limited to a gasoline particulate filter that collects particulate matter contained in an exhaust gas exhausted from a gasoline engine. For example, the porous complex 1 may be used as a diesel particulate filter (DPF) that collects particulate matter contained in an exhaust gas exhausted from a diesel engine. It can be used for collecting particulate matter contained in a gas in other applications. Since the collection of particulate matter refers to separating a gas and particulate matter, the porous complex 1 may also be used in various other applications for separating a gas and particulate matter. Moreover, the characteristic structure of the collection layer may possibly be used in various other applications other than the collection or separation of particulate matter.

The structure of the porous complex 1 may be modified in various ways. For example, the mesh sealing parts 124 may be omitted from the base material 12. Alternatively, the inner surfaces of all of the cells 123 may be used as the collection surfaces on which the collection layer 13 is provided. As yet another alternative, the base material 12 does not necessarily have to have a honeycomb structure, and may have any other shape, such as a tubular shape whose interior is not partitioned by a partitional wall or a flat plate-like shape. The porous complex 1 does not necessarily have to be a single independent member, and may be part of one member.

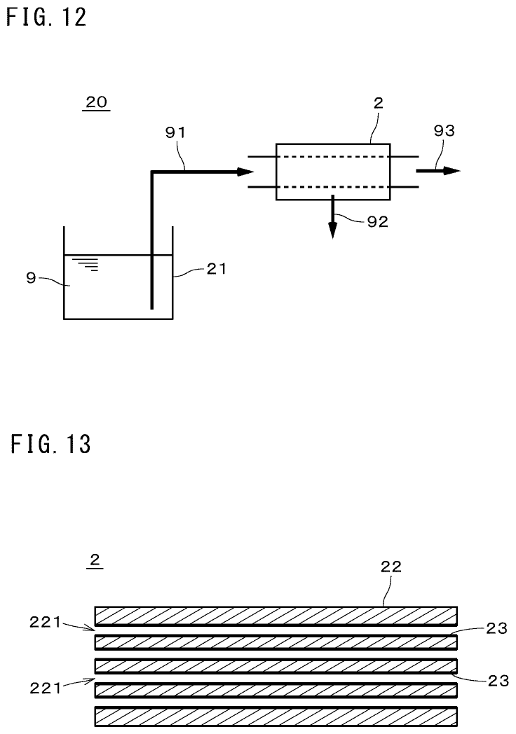

FIG. 12 is a simplified diagram of an algae collector 20 that includes a porous complex 2 according to another embodiment of the present invention. The collection of microalgae (hereinafter, also simply referred to as “algae”) is attracting attention in the field of so-called bioeconomy, and it is expected that microalgae will be used for foodstuffs, fuels, CO₂ collection, sustainable material, and other purposes. The algae collector 20 includes a storage tank 21 and the porous complex 2. The storage tank 21 stores a culture solution 9 obtained by cultivating microalgae. The culture solution 9 is guided to the porous complex 2 by a pump as indicated by an arrow 91, and the porous complex 2 extracts part of water in the culture solution 9 as indicated by an arrow 92 and acquires condensed matter of the remaining microalgae as indicated by an arrow 93.

FIG. 13 is a diagram showing a section of the porous complex 2 that is taken along a plane parallel to the longitudinal direction. The porous complex 2 is a tubular member that is long in one direction and has a plurality of through holes 221 extending in parallel with the longitudinal direction. The porous complex 2 includes a porous base material 22 and a porous surface layer 23. The surface layer 23 forms the inner surface of each through hole 221. The base material 22 has, for example, an approximately circular sectional shape perpendicular to the longitudinal direction. This sectional shape may be any other shape such as a polygonal shape. The culture solution 9 shown in FIG. 12 is introduced into the porous complex 2 from one longitudinal end of the porous complex 2 as indicated by the arrow 91, and a condensed culture solution is drawn out from the other end as indicated by the arrow 93. Moreover, water is drawn out from the outer surface of the porous complex 2 as indicated by the arrow 92.

The base material 22 is a porous member. For example, the base material 22 is formed of cordierite or an aluminum oxide (ceramic such as Al₂O₃). The base material 22 may also be formed of any other ceramic, or may be formed of a material other than ceramic.

The longitudinal length of the base material 22 is, for example, greater than or equal to 160 mm and less than or equal to 1500 mm. The outside diameter of the base material 22 is, for example, greater than or equal to 20 mm and less than or equal to 180 mm. The inside diameter of the through holes 221 is, for example, greater than or equal to 1.6 mm and less than or equal to 3.0 mm. The porosity of the base material 22 is, for example, higher than or equal to 30% and lower than or equal to 60% and preferably higher than or equal to 35% and lower than or equal to 50%. The open porosity of the base material 22 is, for example, higher than or equal to 30% and lower than or equal to 60% and preferably higher than or equal to 35% and lower than or equal to 50%. The porosity and open porosity of the base material 22 can be measured by the Archimedes method.

The mean pore diameter of the base material 22 is, for example, greater than or equal to 3.0 μm and less than or equal to 30.0 μm and preferably greater than or equal to 5.0 μm and less than or equal to 15.0 μm. The mean pore diameter can be measured by a mercury porosimeter. The surface open area ratio of the base material 22 is, for example, higher than or equal to 20% and lower than or equal to 60% and preferably higher than or equal to 25% and lower than or equal to 50%. The surface open area ratio refers to the ratio of the area of a region where the pores are open in the surface of the base material 22, and can be obtained by image analysis of an SEM (scanning electron microscope) image of this surface.

The surface layer 23 is formed on the through holes of the base material 22 and covers the inner surfaces of the through holes. That is, the inner surfaces of the through holes 221 of the porous complex 2 correspond to the surface of the surface layer 23. In FIG. 13, the surface layer 23 is indicated by thick solid lines. Part of water in the culture solution 9 introduced into the through holes 221 flows through the surface layer 23 and the base material 22 and is guided from the outer surface of the porous complex 2 to the outside of the porous complex 2. At this time, algae are deposited on the surface layer 23, and the remainder of the culture solution 9 is guided as a culture solution together with condensed algae from the through holes 221 to the outside. That is, the culture solution 9 is condensed when flowing through the through holes 221.

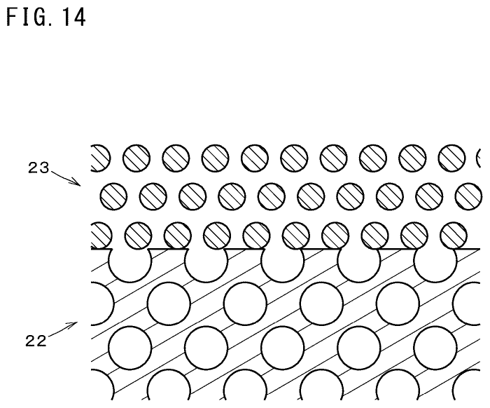

FIG. 14 is a simplified diagram of enlarged longitudinal sections of the base material 22 and the surface layer 23. The “longitudinal sections” refer to planes perpendicular to the surface of the base material 22, and FIG. 14 shows the longitudinal sections parallel to the longitudinal direction of the through holes 221. The basic structure shown in FIG. 14 is the same as that obtained by removing the upper layer 132 from the structure shown in FIG. 4. That is, the structure before forming the upper layer 132 shown in FIG. 4 corresponds to the structure shown in FIG. 14, and FIG. 14 shows the structure corresponding to FIGS. 5A and 6. It is, however, noted that features such as porosity, mean pore diameter, and surface open area ratio that characterize the materials and the structures of the base material 22 and the surface layer 23 are appropriately different from those for the base material 12 and the lower layer 131 shown in FIG. 4.

The base material 22 has large pores and the pores are connected together to provide the base material 22 with air permeability. The surface layer 23 is formed on the base material 22. The surface layer 23 is similar to the lower layer 131 shown in FIGS. 5A, 5B, and 6 and is a three-dimensional network structure that has a novel structure with air permeability. That is, the surface layer 23 has a structure in which silica (SiO₂) continuums including connected granular portions are further connected together in three-dimensional mesh form. This structure is formed by densifying and bonding silica gel (SiO₂·nH₂O) particles by firing (so-called a baking process). In FIG. 14, the sections of large pores of the base material 22 are indicated as large cavities, and the section of the mesh-like structure of the surface layer 23 is indicated as a large number of circles. The surface of the surface layer 23 corresponds to the surface of the porous complex 2. Since the base material 22 and the surface layer 23 have air permeability, the porous complex 2 also naturally has air permeability. The definition of air permeability is as already described for the porous complex 1.

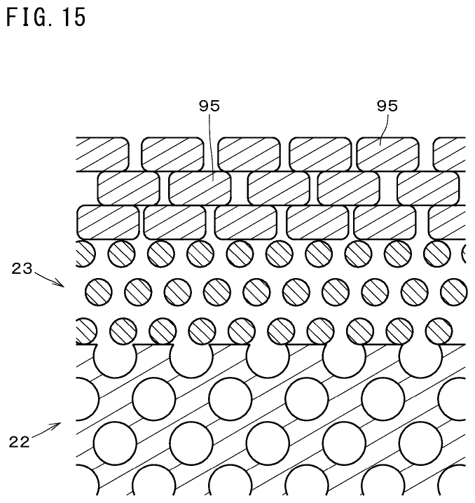

FIG. 15 is a diagram showing a state in which algal particles (hereinafter, also simply referred to as “fine particles”) 95 are deposited on the surface layer 23. When the condensation of the culture solution 9 begins from the state shown in FIG. 14, the fine particles 95 start to be deposited on the surface of the surface layer 23. Thereafter, algal cake layers are formed on the surface layer 23 and stabilized in a state in which the cake layers are stacked one above another as shown in FIG. 15. During this, the permeation volume of water per unit time and per unit area of the porous complex 2 (i.e., the rate of water permeation) will deteriorate gradually, but ultimately a certain level of water permeability is maintained. Ideally, the porous complex 2 exhibits a high rate of water permeation even immediately after the start of the condensation, and a certain level of water permeability is maintained even after the stacking of the cake layers.

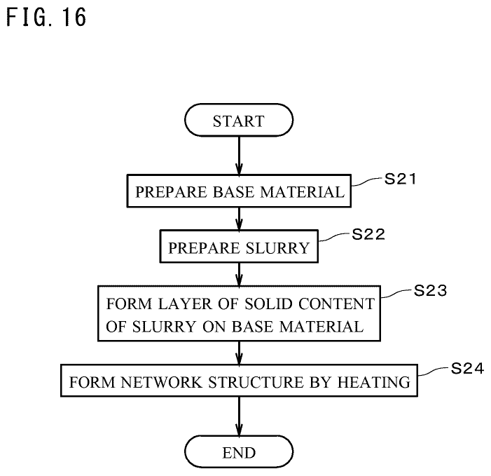

Next, one example of the production of the porous complex 2 will be described. FIG. 16 is a flowchart showing the production of the porous complex 2. Firstly, a porous sintered body with air permeability is prepared as the base material 22 (step S21). Any of various known methods may be used as the method of producing the base material 22. For example, kneaded clay (“hoke”) is produced by mixing and kneading a raw material such as alumina or glass that contains an alkali-alkaline-earth component and a Si component with a pore-forming material such as starch or an acrylic resin, a binder such as methylcellulose, and water. At this time, an oxide such as a transition-metal oxide or a rare-earth oxide may be used as a sintering agent, or a dispersant or surfactant may be added as an auxiliary forming agent. The pore-forming material or the binder may be organic materials other than those described in the above examples. The kneaded mixture is subjected to extrusion molding using a plunger with a nozzle attached thereto, so as to obtain a molded material having a large number of through holes. The moisture in the molded material is removed by hot air drying, organic substances therein are removed by thermal degreasing, and the base material 22 is obtained by firing.

Meanwhile, a slurry containing silica gel particles is prepared aside from step S21, i.e., before or after step S21 or in parallel with step S21 (step S22). The slurry contains at least silica gel particles, a dispersant, and a solvent. Specifically, the slurry is produced by placing and stirring the silica gel particles, the dispersant, and a stabilizer in water. A binder may be added to the slurry.

Then, the slurry is poured into the through holes of the base material 22, and pressure of the space on the outer surface side of the base material 22 is reduced so as to take out the water contained in the slurry from the outer surface. Accordingly, a layer of the slurry (to be precise, a solid content of the slurry) is formed on the inner surface (step S23). That is, the silica gel particles are deposited on the inner surfaces of the through holes, forming aggregates of the silica gel particles on the inner surfaces of the through holes. In the above-described wet deposition of the silica gel particles, the “aggregates of the silica gel particles” refer to aggregates of a material containing the silica gel particles, and the silica gel particles included in the aggregates do not necessarily have to be in direct contact with one anther.

Thereafter, for example, the layer formed on the inner surfaces of the through holes is dried by hot air drying conducted at a temperature of 80° C. for 12 hours in ambient atmosphere, is heated at a temperature of 450° C. for six hours in ambient atmosphere for degreasing to remove organic substances, and is further heated at a temperature of 1250° C. for 10 hours in ambient atmosphere for firing to combine the silica gel particles. Accordingly, a three-dimensional network structure which is the surface layer 23, is formed on the base material 22 (step S24).

Note that the hot air drying is preferably conducted at a temperature of higher than or equal to 50° C. and lower than or equal to 100° C. for 10 hours or more and 24 hours or less. The degreasing is preferably conducted at a temperature of higher than or equal to 400° C. and lower than or equal to 500° C. for 5 hours or more and 7 hours or less. The firing is preferably conducted at a temperature of higher than or equal to 1000° C. and lower than or equal to 1350° C. for 5 hours and more and 15 hours or less, and the rate of temperature rise during firing is higher than or equal to 50° C./hour and lower than or equal to 100° C./hour.

As a method of depositing the silica gel particles on the inner surfaces of the through holes of the base material 22, the dry deposition method shown in FIG. 9 may be adopted, instead of the aforementioned wet filter deposition method. It goes without saying that the aforementioned filter deposition method may also be adopted to form the lower layer 131 shown in FIG. 4.

Next, Examples 2-1 to 2-3 of the porous complex 2 and Comparative Example 2-1 for comparison with the porous complex 2 will be described with reference to Tables 3 and 4.

TABLE 3

| | | Base Material | | | Surface-Layer Forming Conditions | | | | | | | |
|---|---|---|---|---|---|---|---|---|---|---|---|---|
| | | | | Mean | | | | Mean | | | | |
| | | | | Pore | | Impurity | | Pore | Pore | | Firing | Firing |
| | | | Porosity | Diameter | | Cl | S | Diameter | Volume | Deposition | Temperature | Time |
| | | Material | % | μm | Material | wtppm | wt % | μm | cm³/g | Method | ° C. | h |
| Example | 2-1 | Cordierite | 48 | 12 | Silica Gel | 37 | 0.02 | 4 | 1.5 | Filter | 1240 | 10 |
| | | | | | | | | | | Deposition | | |
| Example | 2-2 | Al₂O₃ | 40 | 12 | Silica Gel | 27 | 0.02 | 4 | 1.5 | Filter | 1240 | 10 |
| | | | | | | | | | | Deposition | | |
| Example | 2-3 | Al₂O₃ | 40 | 12 | Silica Gel | 20 | <0.01 | 10 | 1.5 | Filter | 1240 | 10 |
| | | | | | | | | | | Deposition | | |
| Comparative | 2-1 | Al₂O₃ | 40 | 12 | — | — | — | — | — | — | — | — |
| Example | | | | | | | | | | | | |

TABLE 4

| | | Surface Layer | | | | | | | | | | |
|---|---|---|---|---|---|---|---|---|---|---|---|---|
| | | | Section Information | | | | | | | | | |
| | | | Penetration | | | | Membrane Surface | | Mean | | | |
| | | | Depth into | | | Mean | Information | | Diameter of | | | Algal |
| | | | Base | | Mean Pore | Membrane | | Mean Pore | Granular | Impurity | | Permeation |
| | | | Material | Porosity | Diameter | Thickness | Porosity | Diameter | Portions | Cl | S | Rate |
| | | Material | μm | % | μm | μm | % | μm | μm | wtppm | wt % | L/(m² · h) |
| Example | 2-1 | SiO₂ | 0 | 69 | 4.7 | 20 | 46 | 3.3 | 6.0 | <10 | <0.01 | 80 |
| Example | 2-2 | SiO₂ | 0 | 68 | 4.5 | 20 | 46 | 3.3 | 6.0 | <10 | <0.01 | 80 |
| Example | 2-3 | SiO₂ | 0 | 68 | 5.0 | 20 | 40 | 5.0 | 8.5 | <10 | <0.01 | 50 |
| Comparative | 2-1 | — | — | — | — | — | — | — | — | — | — | 35 |
| Example | | | | | | | | | | | | |

### Example 2-1

In Example 2-1, firstly, a base material formed of cordierite was prepared. The base material had a length of 250 mm and an outside diameter of 30 mm, and the base material had 55 through holes having an inside diameter of 2.4 mm. The distance between the central axes of each pair of adjacent through holes was approximately 3.0 mm. The base material had a porosity of 48% and a mean pore diameter of 12 μm.

Silica gel particles with a mean particle diameter of 4 μm and a pore volume of 1.5 cm³/g were deposited on the base material of cordierite by a filter deposition method. In the used silica gel particles, a content of chlorine (Cl) impurities was 37 ppm (on a weight basis; the same applies below), and a content of sulfur(S) impurities was 0.02 wt %. The amount of Cl impurities was measured by dissolving a powdered measurement sample in acid and introducing a resultant solution into an ICP emission spectral analysis device. The amount of S impurities was acquired by a gas componential analysis method. The same applied to the examples and the comparative example described below.

After hot air drying and degreasing, firing was conducted at a temperature of 1240° C. for 10 hours so as to form a surface layer. In the produced porous complex, the penetration depth of the surface layer into the pores of the base material in a longitudinal section of the surface layer of silica, i.e., in a section of the porous complex along a plane perpendicular to the surface of the base material, was 0 μm. In the longitudinal section, the surface layer had a porosity of 69%, a mean pore diameter of 4.7 μm, and a mean membrane thickness (i.e., a mean layer thickness) of 20 μm. In the membrane surface, the surface layer had a porosity of 46% and a mean pore diameter of 3.3 μm, and the mean diameter of the granular portions was 6.0 μm. In the surface layer, a content of Cl impurities was less than a measurement limit value (less than 10 ppm), and a content of S impurities was also less than a measurement limit value (less than 0.01 wt %).

The reason why the surface layer did not penetrate into the pores of the base material was considered because the silica gel particles aggregated and existed as clusters larger than the pores in the slurry.

The various measured values for the base material and the surface layer described above were acquired by techniques similar to those described with reference to Tables 1 and 2 (note that the surface layer corresponded to the lower layer in Table 2). The methods of acquiring the above-escribed measured values for the base material and the surface layer were also used in the same manner as in the examples and the comparative example described below.

In Example 2-1, the algal permeation rate of the porous complex was 80 L/m²·h. The algal permeation rate referred to the rate at which only water permeated through the solution that contained microalgae, and it corresponded to the rate of water permeation after the culture solution had been stably condensed while maintaining the pressure difference between the through holes of the porous complex and the outer surface had become 50 kPa (the same applies below).

### Example 2-2

In Example 2-2, firstly, a base material with aluminum oxide (Al₂O₃) as a main constituent phase (i.e., the qualitative component identified by XRD was an aluminum oxide) was prepared. Note that the base material may have contained a crystal phase other than an aluminum oxide. The base material had a length of 250 mm and an outside diameter of 30 mm, and the base material had 55 through holes having an inside diameter of 2.4 mm. The distance between the central axes of each pair of adjacent through holes was approximately 3.0 mm. The base material had a porosity of 40% and a mean pore diameter of 12 μm.

Silica gel particles with a mean particle diameter of 4 μm and a pore volume of 1.5 cm³/g were deposited on the base material by a filter deposition method. In the used silica gel particles, a content of Cl impurities was 27 ppm, and a content of S impurities was 0.02 wt %.

After hot air drying and degreasing, firing was conducted at a temperature of 1240° C. for 10 hours so as to form a surface layer. In the produced porous complex, the penetration depth of the surface layer into the pores of the base material in a longitudinal section of the surface layer of silica was 0 μm. In the longitudinal section, the surface layer had a porosity of 68%, a mean pore diameter of 4.5 μm, and a mean membrane thickness of 20 μm. In the membrane surface, the surface layer had a porosity of 46% and a mean pore diameter of 3.3 μm, and the mean diameter of the granular portions was 6.0 μm. In the surface layer, a content of Cl impurities was less than a measurement limit value (less than 10 ppm), and a content of S impurities was also less than a measurement limit value (less than 0.01 wt %).

In Example 2-2, the algal permeation rate of the porous complex was 80 L/m²·h.

### Example 2-3

The base material in Example 2-3 was the same as in Example 2-2. Silica gel particles with a mean particle diameter of 10 μm and a pore volume of 1.5 cm³/g were deposited on the base material by a filter deposition method. In the used silica gel particles, a content of Cl impurities was 20 ppm, and a content of S impurities was less than a measurement limit value (less than 0.01 wt %).

After hot air drying and degreasing, firing was conducted at a temperature of 1240° C. for 10 hours so as to form a surface layer. In the produced porous complex, the penetration depth of the surface layer into the pores of the base material in a longitudinal section of the surface layer of silica was 0 μm. In the longitudinal section, the surface layer had a porosity of 68%, a mean pore diameter of 5.0 μm, and a mean membrane thickness of 20 μm. In the membrane surface of the surface layer, the surface layer had a porosity of 40% and a mean pore diameter of 5.0 μm, and the mean diameter of the granular portions was 8.5 μm. In the surface layer, a content of Cl impurities was less than a measurement limit value (less than 10 ppm), and a content of S impurities was also less than a measurement limit value (less than 0.01 wt %).

In Example 2-3, the algal permeation rate of the porous complex was 50 L/m²·h.

### Comparative Example 2-1

Comparative Example 2-1 used the same base material as in Example 2-2. In Comparative Example 2-1, no surface layer was formed. In Comparative Example 2-1, the algal permeation rate was 35 L/m²·h.

As is clear from the examples and the comparative example described above, the presence of the surface layer on the base material improves the algal permeation rate. This is considered because, even if deposited, algae adhering at high density is suppressed because the surface layer is a network structure, and the algae can easily come off from the sedimentary layer and the surface layer.

The surface layer 23 provided on the base material 22 is similar to the lower layer 131 shown in FIG. 4 and has a characteristic structure in which silica (SiO₂) continuums including granular portions are connected together in three-dimensional mesh form. Since the diameters of fine algal particles (the minor axes if the particles are long and narrow) are in the range of approximately 5 μm to 10 μm, it is preferable, from the viewpoint of allowing water to flow without allowing passage of algae, that the network structure is a structure that does not allow passage of particles with a mean particle diameter of greater than or equal to 6.0 μm, and is more preferably a structure that does not allow passage of particles with a mean particle diameter of greater than or equal to 4.0 μm. To realize the characteristics described above, the mean particle diameter of the silica gel particles as a raw material is preferably greater than or equal to 3.0 μm and less than or equal to 12.0 μm and more preferably greater than or equal to 4.0 μm and less than or equal to 6.0 μm. The mean pore volume of the silica gel particles is preferably higher than or equal to 0.5 ml/g and lower than or equal to 2.0 ml/g.

Regarding the heating temperature and the heating time, the silica gel particles are preferably heated at a temperature of higher than or equal to 900° C. and lower than or equal to 1350° C. for 5 hours or more and 15 hours or less, and are more preferably heated at a temperature of higher than or equal to 1100° C. and lower than or equal to 1250° C. for 8 hours or more and 10 hours or less. Then, the mean particle diameter of the granular portions of silica after firing is preferably greater than or equal to 5.0 μm and less than or equal to 10.0 μm and more preferably greater than or equal to 5.5 μm and less than or equal to 6.5 μm. The mean membrane thickness of the surface layer 23 is preferably greater than or equal to 5 μm and less than or equal to 200 μm and more preferably greater than or equal to 20 μm and less than or equal to 150 μm. This allows algae and water to be separated appropriately and suppresses a decrease in permeation rate. Moreover, in order to obtain such a mean membrane thickness of the surface layer 23, the thickness of the sedimentary layer of the silica gel particles that are deposited on the base material 22 after drying of the slurry is preferably greater than or equal to 5 μm and less than or equal to 200 μm and more preferably greater than or equal to 20 μm and less than or equal to 150 μm. The thickness of the sedimentary layer refers to a mean value of the thicknesses of the sedimentary layer deposited in a region where the layer is supposed to be deposited. The “deposition” of the silica gel particles during formation of the surface layer 23 refers to simply stacking the particles by weak force.

Note that the various “preferable” numerical ranges in the above description do not intend to limit the present invention.

The application of the porous complex 2 is not limited to a filter that increases the concentration of algae in the culture solution. Microorganisms other than algae may also be used. One preferable application of the porous complex 2 is a filter that separates microorganisms contained in a liquid from the liquid. Instead of microorganisms, the porous complex 2 may separate an organic or inorganic substance other than microorganisms from a fluid such as a liquid or a gas. The porous complex 2 is also applicable as a filter for increasing the concentration of various fine particles contained in a fluid such as a liquid or a gas. In broad definition, it is applicable as a filter that separates a fluid containing fine particles into a fluid and fine particles. “The separation of a fluid and fine particles” is not limited to perfect separation, and it includes cases such as partial separation in order to allow an increase in the concentration of fine particles in a fluid, or collection of some fine particles contained in a fluid. It also includes a case of obtaining only a fluid from the fluid that contains fine particles. The porous complex 2 is also applicable in various other applications other than the separation of a fluid and fine particles.

The structure of the porous complex 2 may be modified in various ways. For example, the porous complex 2 does not necessarily have to have a large number of through holes 221 and may have any other shape such as a tubular shape or a flat plate-like shape. In the case where the base material 22 has a plate-like shape, one main surface of the base material 22 is brought into contact with a slurry, and pressure is reduced from the other main surface so that a layer of aggregates of the silica gel particles is formed on the one main surface. That is, an aggregate of the silica gel particles can be easily formed on the base material 22 by reducing pressure inside the base material 22 while bringing the slurry containing the silica gel particles into contact with the base material 22 having air permeability.

The porous complex 2 does not necessarily have to be one independent member, and may be part of one member.

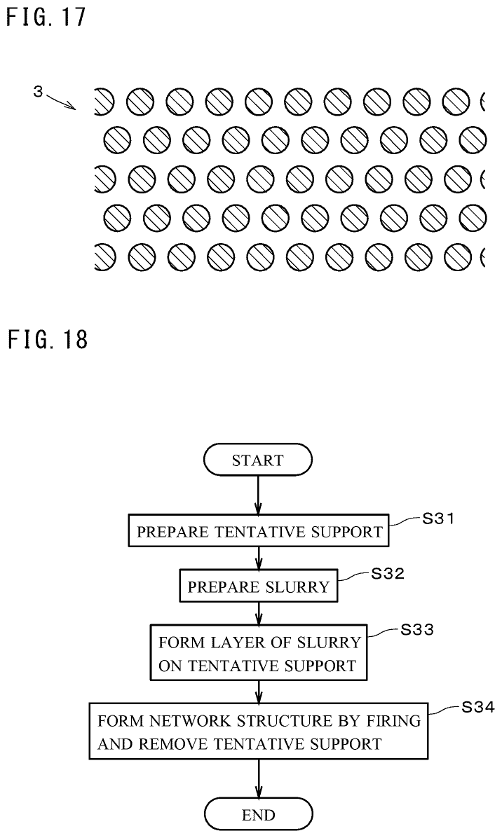

It is found from Examples 2-1 to 2-3 that, in the surface layer 23, the Cl content is less than 10 ppm, and the S content is less than 0.01 wt %. Meanwhile, in the silica gel particles serving as a raw material, the Cl content is in the range of 20 ppm to 37 ppm of Cl, and the S content is in the range of less than a measurement limit value (less than 0.01 wt %) to 0.02 wt %. Thus, Cl and S are removed from the surface layer 23 by firing. The same can be said of the lower layer 131 of the porous complex 1 shown in FIG. 4 and a network structure 3 shown in FIG. 17 described later. It is conceivable from Examples 2-1 to 2-3 that a more excellent network structure can be obtained by firing if at least in the silica gel particles serving as a raw material, the Cl content is higher than or equal to 20 ppm and lower than or equal to 37 ppm, and the S content is less than or equal to 0.02 wt %. Since the presence of at least 37 ppm of Cl is permitted and at least 0.02 wt % of S is permitted, it is conceivable that an excellent network structure can also be obtained if in the silica gel particles as a raw material, the Cl content is higher than or equal to 20 ppm and lower than or equal to 0.01 wt %, and the Si content is lower than or equal to 0.1 wt %.

FIG. 17 is a longitudinal sectional view showing the network structure 3 according to yet another embodiment of the present invention.

The network structure 3 corresponds to the lower layer 131 of the porous complex 1 shown in FIG. 4 and corresponds to the surface layer 23 of the porous complex 2 shown in FIG. 14. That is, the porous complex 2 shown in FIG. 14 is obtained by firing the network structure 3 on a porous support, and the porous complex 1 shown in FIG. 4 is obtained by further firing a porous layer on the porous complex 2. The network structure 3 shown in FIG. 17 is assumed to be not provided on a support, but the network structure 3 may be fired on a porous or non-porous support, or may be bonded to a porous or non-porous support with an adhesive.

In the case where the network structure 3 is not provided on a support, the network structure 3 may have a plate-like shape or a block-like shape. A relatively fine network structure 3 may be present as a powder-type aggregate. The way of providing the network structure 3 may be modified in various ways depending on the application purpose. As described previously, the network structure 3 has a characteristic structure in which silica (SiO₂) continuums including granular portions are connected together in three-dimensional mesh form.

In consideration of application to various application purposes, the mean particle diameter of the silica gel particles as a raw material during formation of the network structure is preferably greater than or equal to 0.1 μm and less than or equal to 15 μm. The mean pore volume of the silica gel particles is preferably greater than or equal to 0.2 ml/g and less than or equal to 3.0 ml/g. Regarding the heating temperature and the heating time, the silica gel particles are preferably heated at a temperature of higher than or equal to 800° C. and lower than or equal to 1450° C. for 3 hours or more and 20 hours or less. Then, the mean particle diameter of the granular portions of silica after firing is preferably greater than or equal to 0.8 μm and less than or equal to 10 μm.

Note that the various “preferable” numerical ranges in the above description do not intend to limit the present invention.

FIG. 18 is a flowchart showing the production of the network structure 3 that is not supported on a support. Firstly, a tentative support that can be removed by combustion is prepared (step S31). The tentative support may have any shape such as a sheet-like shape, a plate-like shape, or a block-like shape, and for example, materials such as a synthetic material including polyurethane or a natural material including seaweed may be adopted. Separately from step S31, a slurry of silica gel particles is prepared (step S32). The slurry is prepared by a technique similar to that used in step S22 shown in FIG. 16.

Then, a layer of the slurry is formed on the tentative support by doctor blading or the like (step S33). Accordingly, an aggregate of the silica gel particles is obtained. By hot air drying, degreasing, and firing, the silica gel particles are sintered to form the network structure 3, and the tentative support is removed by incineration (step S34). Through the steps described above, the network structure 3 having a novel structure is obtained. Note that the hot air drying is preferably conducted at a temperature of higher than or equal to 50° C. and lower than or equal to 90° C. for 10 hours or more and 24 hours or less. The degreasing is preferably conducted at a temperature of higher than or equal to 300° C. and lower than or equal to 600° C. for 5 hours or more and 24 hours or less. The firing is preferably conducted at a temperature of higher than or equal to 1000° C. and lower than or equal to 1250° C. for 5 hours or more and 24 hours or less, and the rate of temperature rise during firing is higher than or equal to 10° C./hour and lower than or equal to 300° C./hour.

The network structure 3 can be used as a filter that separates a fluid containing fine particles into the fluid and the fine particles. “The separation of a fluid and fine particles” is not limited to perfect separation, and may include cases such as partial separation in order to increase the concentration of fine particles in a fluid, and collection of some fine particles contained in a fluid. It also includes the case of obtaining only a fluid from the fluid containing fine particles. Moreover, the network structure 3 can also be used in various other applications other than the separation of a fluid and fine particles.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1,2 porous complex
3 network structure
9 culture solution
12, 22 base material
23 surface layer
51 granular portion
52 joining portion
95 fine (algal) particles
131 lower layer
132 upper layer
1311 silica gel particles
S11 to S15, S21 to S24, S31 to S34 step

1. A network structure comprising:
a plurality of granular portions formed of silica; and
a plurality of joining portions formed of silica and connecting said plurality of granular portions to form a three-dimensional mesh-connected continuum together with said plurality of granular portions.

2. The network structure according to claim 1, wherein
said plurality of granular portions have a mean particle diameter of greater than or equal to 0.8 μm and less than or equal to 10 μm.

3. The network structure according to claim 1, wherein
a chlorine content is less than 10 ppm on a weight basis, and
a sulfur content is less than 0.01 wt %.

4. A porous complex comprising:
a base material that is a porous sintered body having air permeability; and
the network structure according to claim 1, said network structure being provided on said base material.

5. The porous complex according to claim 4, wherein
said network structure has a mean membrane thickness of greater than or equal to 5 μm and less than or equal to 200 μm above said base material.

6. The porous complex according to claim 4, wherein
said base material has a mean pore diameter of greater than or equal to 10 μm and less than or equal to 30 μm.

7. The porous complex according to claim 4, further comprising:
an upper layer provided on said network structure, the upper layer being a porous sintered body that has air permeability and has a smaller mean pore diameter than said base material.

8. The porous complex according to claim 7, wherein
said upper layer is formed of alumina.

9. The porous complex according to claim 7, wherein
said upper layer has a mean pore diameter of greater than or equal to 1.0 μm and less than or equal to 1.5 μm.

10. The porous complex according to claim 7, wherein
said upper layer has a mean membrane thickness of greater than or equal to 15 μm and less than or equal to 40 μm.

11. The porous complex according to claim 4,
the porous complex serving as a filter that separates a microorganism contained in a liquid from said liquid.

12. The porous complex according to claim 7,
the porous complex serving as a particulate filter that collects particulate matter contained in an exhaust gas exhausted from a gasoline engine or a diesel engine.

13. A method of producing a network structure, comprising:
a) forming an aggregate of silica gel particles having a mean particle diameter of greater than or equal to 0.1 μm and less than or equal to 5.0 μm; and
b) obtaining a network structure formed of silica by heating said aggregate at a temperature of higher than or equal to 1200° C. and lower than or equal to 1400° C. for 0.5 hours or more and two hours or less.

14. The method of producing a network structure according to claim 13, wherein
said silica gel particles have a mean pore volume of higher than or equal to 0.2 ml/g and lower than or equal to 3.0 ml/g.

15. The method of producing a network structure according to claim 13, wherein
a chlorine content in said silica gel particles is higher than or equal to 20 ppm on a weight basis and lower than or equal to 0.01 wt %, and
a sulfur content in said silica gel particles is lower than or equal to 0.1 wt %.

16. The method of producing a network structure according to claim 13, wherein
in said operation a), said aggregate is formed by forming a slurry containing said silica gel particles.

17. A method of producing a porous complex, comprising:
c) preparing a base material that is a porous sintered body having air permeability; and
d) by the method of producing a network structure according to claim 13, forming said network structure on said base material.

18. The method of producing a porous complex according to claim 17, wherein
in said operation a), said aggregate is formed on said base material by depositing said silica gel particles on said base material.

19. The method of producing a porous complex according to claim 18, wherein
in said operation a), said silica gel particles are deposited to a thickness of greater than or equal to 20 μm and less than or equal to 50 μm on said base material.

20. The method of producing a porous complex according to claim 18, wherein
in said operation a), said aggregate of said silica gel particles is formed on said base material by reducing pressure inside said base material while bringing a slurry containing said silica gel particles into contact with said base material.

21. The method of producing a porous complex according to claim 17, comprising:
e) depositing an upper-layer material particles on said network structure, the upper-layer material particles having a mean particle diameter of greater than or equal to 0.05 μm and less than or equal to 1.0 μm; and
f) forming an upper layer by heating said upper-layer material particles, the upper layer being a porous sintered body having air permeability and having a smaller mean pore diameter than said base material.

22. The method of producing a porous complex according to claim 21, wherein
said upper-layer material particles are alumina particles.
